(19) United States
(12) Patent Application Publication
(10) Pub. No.: US 2025/0327754 A1
(43) Pub. Date: Oct. 23, 2025

(54) LED thermal contrast assay and reader

(71) Applicant: Vigilant Diagnostics, LLC, St. Paul, MN (US)

(72) Inventor: Tomokazu Sato, Minneapolis, MN (US)

(21) Appl. No.: 18/872,114

(22) PCT Filed: Jun. 6, 2023
(86) PCT No.: PCT/US2023/024586

§ 371 Date: Dec. 5, 2024

Related U.S. Application Data
(60) Provisional application No. 63/349,380, filed on Jun. 6, 2022.

(51) Int. Cl. G01N 21/84; G01N 21/35

(52) U.S. Cl. CPC G01N 21/8483; G01N 21/35; G01N 2201/08

(57) ABSTRACT

A thermal contrast assay reader (200) includes a light emitting diode (LED) source element (202), a sensor (208), and I/O circuitry and an opening to receive a sample (206). The reader (200) is configured to convert the sensor results to an output signal representative of light incident onto a test region (214) of the sample (206). The sensor (208) is an infrared sensor configured to measure thermal contrast in the test region (214) of the sample (206).

### FIELD

The present disclosure relates to assays and readers for detecting analytes in a biological sample. More specifically, the present invention relates to assays and readers that operate based upon thermal contrast.

### BACKGROUND

LFA (lateral flow assay, or lateral flow immunoassay, also called rapid diagnostic test (RDT), or bioassays) technology has found widespread use both in and out of laboratory settings. In a typical assay, a fluid specimen from a patient is applied to a sample, such as a test strip. The specimen interacts with chemicals on the sample causing a portion of the sample to optically change characteristics. The visual indicator may be observed by a person, for example, using a home pregnancy test.

### SUMMARY

One general aspect includes a thermal contrast assay reader including a light emitting diode (LED) source element; a sensor; and I/O circuitry and an opening to receive a sample. The reader is configured to convert the sensor results to an output signal representative of light incident onto a test region of the sample. The sensor is an infrared sensor configured to measure thermal contrast in the test region of the sample.

Implementations may include one or more of the following features. The thermal contrast assay reader may include a lateral flow assay (LFA) such as a strip containing reagents, that is placed into the TCA such as, for example, in a slot or holder. The LFA is positioned between the LED source element and the sensor, adjacent the LED source element, the LFA having a window configured to reflect infrared (IR) light from the LED source element. The LED source element may include an LED chip having an LED coupling light to the lateral flow assay (LFA). The LFA is positioned between the LED source element and the sensor. The window in one embodiment is an optically transparent structure which may comprise, by way of example only and not by way of limitation, glass, zinc selenide, plastic, or similar optical substrate (calcium fluoride, magnesium fluorite, sapphire). The LFA is configured to thermally image from an opposite side of a sample from the LED source element. The thermal contrast assay reader and may include a camera operating in a visual range, the camera configured to detect a presence and a proper orientation of the LFA. The camera is a CMOS camera. The camera is a CCD camera. The camera is further configured to detect and read information encoded in a barcode, QR code, or similar information coding pattern of the LFA. The camera is further configured to confirm light intensity of light from the LED source element. The thermal contrast assay reader and may include a light intensity measuring detector including circuitry used to validate or perform feedback on power generated by the LED source element. The light intensity measuring detector is a photodiode. The thermal contrast assay reader and may include a light intensity measuring detector including circuitry configured to check health of the LED source element and driving circuitry associated with the LED source element. The light intensity measuring detector is configured to check health of the LED source element and the driving circuitry by assessing an emission intensity and temporal pattern of light emitted from the LED source element. Light intensity detection is used one way to assess a health of the system. Additional electrical measurements may also be made for health assessment. The thermal contrast assay reader and may include: a lateral flow assembly (LFA); and an optical assembly between the LED source element and the LFA. The optical assembly is configured to couple to the sensor via emitting area projection onto the LFA surface, with an angled window to separate visual and infrared light paths. The angled window is glass. The angled window is plastic. The angled window is a similar optical substrate (calcium fluoride, magnesium fluorite, sapphire). The optical assembly may include a first lens and a second lens, the first lens and the second lens positioned between the LED source element and the angled window, the first lens and the second lens configured to present light across an entirety of the LFA for simultaneous illumination of a test region and a background region of the LFA, and the angled window to reflect infrared light from a sample in the LFA to the sensor. The optical assembly may include fiber optic cables configured to couple light from the LED source element to a sample, and a lens at an end of the fiber optic cables distal to the LED source element. An LED chip typically contains a single LED. The individual LED of the LED chip is configured to be turned on and off. The optical assembly may include two or more LED chips, and therefore two or more LEDs, and one or more fiber optic cables for each LED chip. Each fiber optic cable is configured to couple light from its LED chip to a sample, and a lens or set of lenses at an end of each fiber optic cable distal to its LED chip. The thermal contrast assay reader may include a calibration component, the calibration component may include a movable stage, a photodiode with a pinhole on the movable stage, and a calibration strip for aligning light from the LED chip to the photodiode for calibration. The optical assembly may include: a plurality of LEDs on the LED chip; a plurality of fiber optic cables configured to carry light from the plurality of LEDs; a lens coupled to an end of the bundle, the lens configured to distribute light from the bundle to a sample in the LFA; and an angled window positioned between the lens and the LFA to separate visual and infrared light paths. The angled window is glass. The angled window is plastic. The angled window is a similar optical substrate (calcium fluoride, magnesium fluorite, sapphire). The angled window is positioned to reflect infrared light from the sample in the LFA to the sensor. Further, the designs of the present disclosure may include multiple LED chip, each having one, or multiple, emitting areas that can be individually addressed. Each LED chip may be independently addressable, or may be operated all together.

Another general aspect includes a thermal contrast assay reader. The thermal contrast assay reader also includes a light emitting diode (LED) source element; a sensor; and a lateral flow assay (LFA) tray which may include input/output (I/O) circuitry and an opening to receive a sample. The reader is configured to convert the sensor results to an output signal upon activation of the LED source element onto a test region of the sample. The sensor is an infrared sensor configured to measure thermal contrast in the test region of the sample.

Implementations may include one or more of the following features. The thermal contrast assay reader where the LFA tray is positioned between the LED source element and the sensor, adjacent the LED source element, the LFA tray having a window configured to reflect infrared (IR) light from the LED source element. The LED source element may include an LED chip having at least one LED coupling light to the LFA tray. The LFA tray is positioned between the LED source element and the sensor. The window is a transparent coverslip may include glass, plastic, or similar optical substrates. The LFA tray is configured to thermally image from an opposite side of a sample from the LED source element. The thermal contrast assay reader and may include a camera operating in a visual range, the camera configured to detect a presence and a proper orientation of the LFA tray. The camera is a CMOS camera. The camera is a CCD camera. The camera is further configured to detect and read information encoded in a barcode, QR code, or similar information coding pattern of the LFA tray. The camera is further configured to confirm light intensity of light from the LED source element. The thermal contrast assay reader and may include a light intensity measuring detector including circuitry used to validate or perform feedback power generated by the LED source element. The light intensity measuring detector is a photodiode. The thermal contrast assay reader and may include a light intensity measuring detector including circuitry configured to check health of the LED source element and driving circuitry associated with the LED source element. The light intensity measuring detector is configured to check health of the LED chip and the driving circuitry by assessing an emission intensity and temporal pattern of light emitted from the LED chip. The thermal contrast assay reader and may include an optical assembly between the LED source element and the LFA tray. The optical assembly is configured to couple to the sensor via emitting area projection onto the sample, with an angled window to separate visual and infrared light paths. The angled window is glass, plastic, or similar optical substrate. The optical assembly may include a first lens and a second lens, the first lens and the second lens positioned between the LED chip and the angled window, the first lens and the second lens configured to present light across an entirety of the sample for simultaneous illumination of a test region and a background region of the LFA tray, and the angled window to reflect infrared light from the sample to the sensor. The optical assembly may include fiber optic cables configured to couple light from the LED chip to a sample, and a lens at an end of the fiber optic cable distal to the LED chip. Individual LEDs of the LED chip are configured to be individually turned on and off. The optical assembly may include two LED chips, and one or more fiber optic cables for each LED chip, each fiber optic cable configured to couple light from its LED chip to a sample, and a lens at an end of each fiber optic cable distal to its LED chip. The thermal contrast assay reader and may include a calibration component, the calibration component may include a movable stage, a photodiode with a pinhole on the movable stage, and a calibration strip for aligning light from the LED chip to the photodiode for calibration. The optical assembly may include: a plurality of LEDs on the LED chip; a bundle of a plurality of fiber optic cables configured to carry light from the plurality of LEDs; a lens coupled to an end of the bundle, the lens configured to distribute light from the bundle to the sample; and an angled window positioned between the lens and the LFA tray to separate visual and infrared light paths. The angled window is glass, plastic, or similar optical substrate. The angled window is positioned to reflect infrared light from the sample to the sensor.

Another general aspect includes a method of illumination pattering for a thermal contrast assay reader. The method also includes illuminating a sample on a lateral flow assay (LFA) with LED light from an LED source; and sensing a thermal contrast in the sample with a sensor.

Implementations may include one or more of the following features. The method where sensing and illuminating are done from opposite sides of the LFA. Illuminating is performed with a direct illumination of the LFA by the LED source. Illuminating is performed with an optical assembly between the LED source and the LFA. Illuminating is performed by coupling the sensor emitting area projection onto the LFA surface, using an angled window to separate visual and infrared light paths. The optical assembly illuminates the sample by positioning a first lens and a second lens between the LED source and the angled window, and by presenting light across an entirety of the LFA for simultaneous illumination of a test region and a background region of the LFA. Illuminating is performed by coupling light from the LED source to a sample through fiber optic cable. Illuminating is further performed by coupling light from the fiber optic cables through lenses at an end of the fiber optic cables distal to the LED light source. Each LED source is individually controllable. The LFA may be addressed by a movable stage, and where illumination is performed by spatially changing a position of the sample relative to light presented to the sample. Illuminating is performed by: a plurality of fiber optic cables configured to carry light from a plurality of LEDs; presenting light from the plurality of fiber optic cables to a lens coupled to an end of the bundle; and directing the light to the sample through an angled window positioned between the lens and the LFA to separate visual and infrared light paths. LED thermal contrast assay and reader.

Another general aspect includes a thermal contrast assay reader, including a light emitting diode (LED) source element, a lateral flow assay (LFA) including I/O circuitry and an opening to receive an sample, and an infrared sensor configured to measure thermal contrast in a test region of the sample in the LFA. The reader is configured to present LED light to a lateral flow assay (LFA), to block infrared light to the LFA. The reader is further configured to present infrared light emitted from the LFA to the sensor and to convert sensor results to an output signal representative of light incident onto a test region of the sample.

### BRIEF DESCRIPTION OF THE DRAWINGS

FIG. 1 is a simplified diagram showing a lateral flow assay test strip and reader system on which embodiments of the present disclosure may be practiced;

FIG. 2 is a diagram of a direct LED coupling reader according to an embodiment of the present disclosure;

FIG. 3 is a diagram of LED coupling via emitting area projection according to another embodiment of the present disclosure;

FIG. 4 is a diagram of LED coupling to fiber according to another embodiment of the present disclosure;

FIG. 5 is a diagram of bundled fiber LED coupling according to another embodiment of the present disclosure;

FIG. 6 is a graph of temperature versus time for an embodiment of a direct LED coupling reader;

FIGS. 7-12 are illustrations of results of an exemplary test on an embodiment of LED coupling via emitting area projection;

FIGS. 13-14 are perspective and cutaway views, respectively, of a system on which embodiments of the present disclosure may be practiced;

FIG. 15 is an image of a radially symmetric Gaussian beam;

FIG. 16 shows a fiber/light pipe guide option to the embodiment of FIG. 2;

FIG. 17 shows a focusing mirror option to the embodiment of FIG. 3;

FIG. 18 shows a single fiber beamsplitter option to the double fiber embodiment of FIG. 4;

FIG. 19 shows a spatial toggling configuration option with a single module having multiple controllable areas to the embodiment of FIG. 2;

FIG. 20 shows a representative spatial toggling option 2000;

FIG. 21 shows a representative single continuous illumination area;

FIG. 22 shows a representative single discontinuous illumination area;

FIG. 23 shows multiple independent controllable illumination areas;

FIG. 24 is a graph of temperature versus time for temporal control of LED illumination according to an embodiment of the present disclosure;

FIG. 25 is a graph of temperature versus time for modulation of LEDs according to an embodiment of the present disclosure;

FIG. 26 illustrates an embodiment of single pixel sensors covering a sample;

FIG. 27 illustrates an embodiment of a sample with a sample membrane over a conducting background according to an embodiment of the present disclosure;

FIG. 28 is a block diagram of a system according to an embodiment of the present disclosure;

FIG. 29 illustrates a typical LFA and illumination thereof;

FIG. 30 shows a modified sample with test area according to an embodiment of the present disclosure;

FIG. 31 shows a modified sample with test area according to another embodiment of the present disclosure;

FIG. 32 shows a modified cartridge according to an embodiment of the present disclosure;

FIG. 33 shows a modified cartridge according to another embodiment of the present disclosure;

FIG. 34 shows a modified cartridge according to yet another embodiment of the present disclosure;

FIG. 35 illustrates an embodiment of a sample with multiple test areas;

FIG. 26 illustrates an embodiment having cylindrical and/or rod lenses for illumination of multiple test areas on a sample;

FIG. 37 illustrates an embodiment having multiple individual LED chops illuminating test areas of a sample; and

FIG. 38 illustrates an embodiment having multiple nonlocal LED sources coupled to a sample via fiber optics.

### DETAILED DESCRIPTION OF ILLUSTRATIVE EMBODIMENTS

Embodiments of the disclosure generally provide LED based thermal contrast assay readers with an emission area either directly or indirectly projected onto relevant regions of a sample, such as but not limited to, LFA, microfluidics, or other detection components where the presence of a target molecule for detection lead to increased or decreased binding of particles used to generate thermal contrast, or to use multiple LEDs individually illuminating distinct and spatially confined regions of an LFA.

As referred to herein, the term sample may be used to refer to an entirety of a cartridge or any direct packaging, an LFA or microfluidic or similar portions where a specimen is run through and analyzed via molecular interactions and later studied with illumination and thermal contrast, and the specimen itself. A sample typically includes a location to apply a specimen. Such a location includes, for example and not by way of limitation, an assay strip or the like, an area (control line or region) that will bind gold nanoparticles (GNPs) or other thermal-contrast generating molecules to demonstrate that the specimen has been correctly run, an area (e.g., a test line(s), multi-test line(s), test region(s) of multi-test region(s)) that will bind the GNPs or other molecules in the presence of a target molecule (e.g., a viral antigen, drug, antibody, etc.) that is being detected in the specimen in a manner somewhat proportional to the concentration of this target molecule, and the areas that the specimen travels through or on (usually a fluidic channel or a matrix). Control and test areas may be specially modified (chemically, biologically, molecularly) areas of the background (e.g., the floor of a fluidic channel, portion of matrix, etc.) to perform this binding. Background may also more generally and interchangeably be used to include parts above and below that may also absorb illumination. For example, if the backside of a cartridge generates a significant thermal signal from illumination, that signal is taken into account when obtaining contrast of the test area, and hence is a background signal that may be adjusted accordingly. Thermal-contrast generating molecules are molecules like GNPs that are used to generate thermal contrast via their quantitative binding to the sample's test regions in a manner dependent on the concentration of the target molecule to be detected in a specimen. In many cases, the same molecule will also provide visual contrast which may be used for detection in traditional tests. These molecules will typically heat more than the backgrounds of the sample. Where the term LFA alone is used, it should be understood that “sample” also applies without departing from the scope of the disclosure.

An assay reader can provide more accurate results than a visual indicator. Such a reader may, for example, include a sensitive optical sensor that is capable of sensing optical variations more accurately and in a more repeatable manner than a human viewer. One example of a typical assay reader is shown in U.S. Pat. No. 7,297,529, to Polito et al., issued Nov. 20, 2007.

The ability to rapidly identify diseases enables prompt treatment and improves outcomes. This possibility has increased the development and use of rapid point-of-care diagnostic devices or systems that are capable of biomolecular detection in both high-income and resource-limited settings. LFAs are inexpensive, simple, portable and robust, thus making LFAs commonplace in medicine, agriculture, and over-the-counter personal use, such as for pregnancy testing. LFAs are also widely used for a number of infectious diseases, such as malaria, AIDS-associated cryptococcal meningitis, pneumococcal pneumonia, and recently tuberculosis.

Although the analytical performance of some LFAs are comparable to laboratory-based methods, the analytical sensitivity (alternatively called limit of detection) of most LFAs is in the mM to μM range, which is significantly less sensitive than other molecular techniques such as enzyme-linked immmunoassays (ELISAs). As a consequence, LFAs are not particularly useful for early detection in a disease course when there is low level of antigen. Research has focused on developing microfluidics, biobarcodes and enzyme-based assay technologies to obtain higher sensitivity in antigen detection since these techniques may potentially detect in the nM to pM range.

As is now well known, the optical, thermal and electrical properties of materials change dramatically in the nanoscale. In particular, the enhanced photothermal signature of metal nanoparticles have been utilized for: thermal ablation of malignant tumors, detecting circulating tumor cells, photothermal gene transfection, enhancing the therapeutic efficiency of chemotherapeutics, and for tracking the transport of nanoparticles within cells.

Thermal contrast assay readers have been used to combat some of these issues. The intensity and power of light used for LFAs in thermal contrast assay readers has limited the light sources to high intensity light such as laser light.

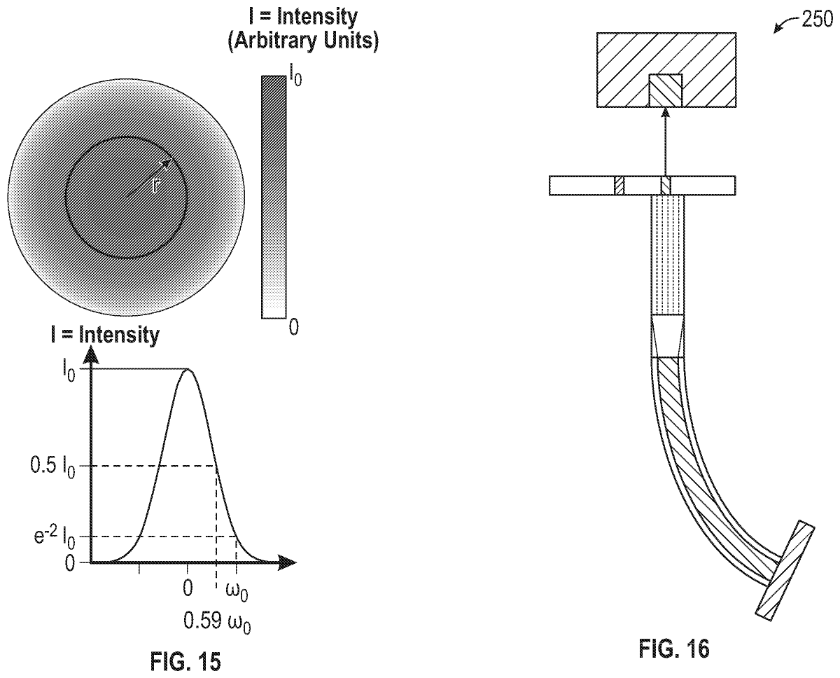

Thermal contrast assay (TCA) for subvisual samples with ˜20 mW (P(∞)=20 mW) lasers with a ˜1.2 mm beam diameter (ω0=0.6 mm) is feasible. Assuming a 2-D radially symmetric Gaussian beam profile as shown in FIG. 15:

$$I ( r ) = {I}_{0} exp ( - \frac{2 {r}^{2}}{{ω}_{0}^{2}} )$$

The total power contained is found by the 2-D integral

$$P ( ∞ ) = ( \frac{{πω}_{0}^{2}}{2} ) I ( 0 )$$

The center intensity has the formula

$$I ( 0 ) = P ( ∞ ) ( \frac{2}{{πω}_{0}^{2}} )$$

Thus, the intensity at the center of the beam is ˜35 mW/mm². Based on the types of LEDs previously available, such power would not be available. With the advent of higher power LEDs, some higher power LEDs have intensities above 700 mW/mm², which given the estimated power requirements for TCA, is possible with LEDs.

However, given that light collection from LEDs is far more difficult than from lasers, and that they may be used in thermal contrast assay readers for a potentially much larger area of illumination, the final intensities at the sample can quickly drop to between 1˜10% of the intensity at the LED surface in some designs. A laser beam is collimated and can travel long distances without spreading. In addition, a laser beam typically has a small diameter, allowing it to be redirected, focused, or defocused with small diameter optics. These properties have made their use in TCA readers simple, especially in methods where the laser beam is scanned along the sample using linear stages or tilting mirrors.

In contrast, LEDs present a number of difficulties to be addressed. First, the light from an LED spreads rapidly from the surface, often in a near Lambertian pattern. A 45-degree capture angle by a lens (lens with f-number of 0.5) from a Lambertian emitter has a capture percentage of around 50%, and such lenses are already rare, highlighting the difficulties in light capture. Second, basic laws of optics, such as those concerning etendue, a property of light describing how spread out the light is in area and angle, place further constraints on the lenses and distances between them and the sample.

LEDs also present a number of advantages over lasers and other collimated light sources. LED advantages include, for example, lower cost, higher total optical power for a given price point, solid state construction and therefore increased robustness, simpler implementation, smaller form factors, and the ability to illuminate both a test region and a background simultaneously due to their high power. While LEDs are simpler to implement, they often use additional optics for properly presenting light to a sample.

A number of designs of the present disclosure use a beamsplitter placed in between any lenses and a sample, placing further constraints which would not allow a simple design of two lenses with f-number of 0.5 to be used. For a number of embodiments disclosed herein, the LED is used to illuminate a larger area than that used in previous TCA implementations. The intensity falls as the square of the magnification. While LED emission areas are larger than typical laser beam diameters, they are still often smaller than the desired illumination area of an LFA. If an LED of size 2.5 mm×1.5 mm emission area were to be used, one may need to magnify the LED image by a factor of 2 to create a 5 mm×3 mm illuminated area which may capture enough background area in addition to the test area of some LFAs, but result in an immediate drop of intensity to 25%. To illuminate an 8 mm stretch of the LFA, one would immediately see intensity drop to 10%. Use of larger LED emission areas also have their share of problems. Such high power LEDs have specific thermal dissipation needs and high power usage, which often limit how large they can be. Collection of light from LEDs whose emitting area reaches dimensions on a similar scale to the lens diameters also increase complexity.

Sufficient collection of illumination from LEDs and directing that illumination onto samples in an LFA, and illumination of test areas such as test lines and/or regions, multi-test lines and/or regions, as well as background regions are discussed in further detail below in relation to several approaches.

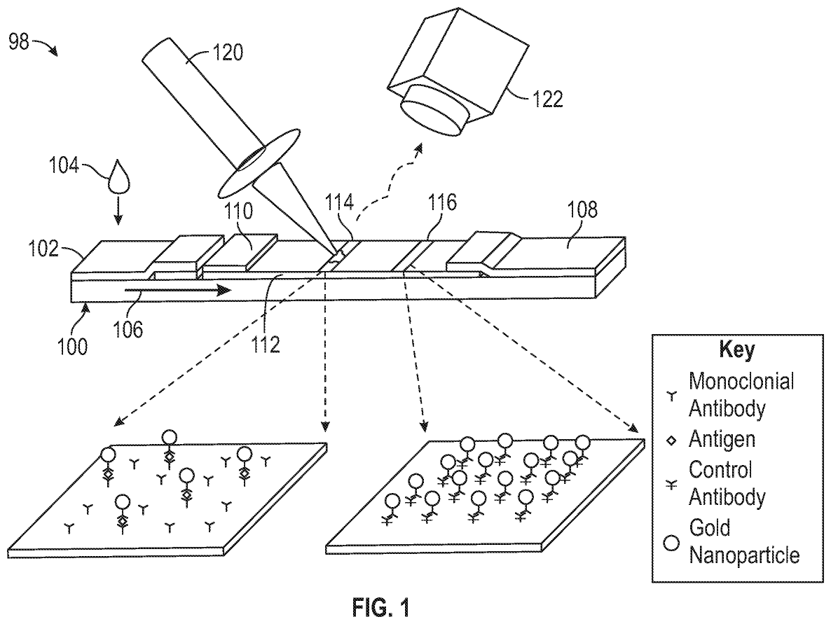

Before a detailed discussion of the embodiments of the disclosure, a background in a general system of thermal contrast assay reading is shown in FIG. 1.

FIG. 1 illustrates one exemplary embodiment and other configurations for conducting lateral flow assays are known in the art and also within the scope of the invention.

FIG. 1 is a simplified diagram showing an exemplary embodiment of a lateral flow assay test and reader system 98 which may be used with embodiments of the present disclosure. A test strip 100 includes a sample pad 102 that is configured to receive a specimen 104 from a patient. Capillary action causes the specimen 104 to flow from the sample pad 102 in the direction indicated by arrow 106 towards absorbent pad 108. Specimen 104 flows through a conjugate pad 110 and through a membrane 112 until it reaches a test region 114. A separate control region 116 is also provided. Test strip 100, sample pad 102, absorbent pad 108, conjugate pad 110, test region 114 and control region 116 are all in fluid communication. “Fluid communication” as used herein refers to the ability of liquid to flow or travel between the stated materials or surfaces.

As illustrated in the inset of FIG. 1, an exemplary embodiment of the test region can include gold nanoparticles associated with a monoclonal antibody bonded with the antigen at test region 114. The amount of bonded gold nanoparticles bonded in test region 114 can be determined by applying energy 120 causing heating of the test region 114. A thermal sensor 122 directed at the test region 114 measures the heating of the test region 114 that is related to the amount of nanoparticles and therefore the amount of antigens present in the test region 114. As explained below in more detail, this can be used to diagnose a condition of the patient. The energy 120 is in one embodiment LED energy that causes heating of test region 114. Energy source 120 and sensor 122 may be housed in one unit. Alternatively, they may be housed separately.

In the embodiment depicted in the FIG. 1 inset, the analyte binding molecules and capture molecules are shown to be monoclonal antibodies. The analyte binding molecule and the capture molecules may be the same type of molecule, i.e. an antibody. In such instances, they preferably bind the analyte at different sites, in other words, the analyte binding molecule and the capture molecule preferably do not bind to the same site or epitope of the analyte. Alternatively, the analyte binding molecule and the capture molecule can be two different molecules, but both capable of binding the analyte at different sites.

In the exemplary embodiment discussed above, antibody-coated GNPs are moved within a nitrocellulose strip through capillary action after the strip has been dipped or contacted with a clinical specimen. When present, the target antigen binds to monoclonal antibody-coated GNPs. This bound complex stops wicking up the “dipstick” when captured by an antibody on the membrane that recognizes the antigen-antibody-GNP complex. This leads to accumulation of GNPs at the test region 114 of the LFA, creating a positive test result. GNPs have been used for LFAs because their size can be designed to migrate through the pores of the membrane 112; GNPs can be coated with antibodies easily; and GNPs have a strong interaction with visible light thus producing deep color that is easily visualized. GNPs that have strong interaction with light at other light wavelengths may be used for thermal contrast detection, for instance gold nanorod with maximum light absorption in the near infrared.

Using LED light for the illumination source in an LFA such as that shown above with respect to FIG. 1 is described in detail in several different approaches below.

Embodiments of the present disclosure provide LED light to an LFA. The LED's infrared (IR) light/emission does not reach the sensor or sample. IR light emitted from the LFA sample from heating does reach the sensor. This basic configuration of a process may be performed in a large number of ways with a variety of optical components and elements, some of which are discussed herein. It will be evident to one of skill in the art that other designs to accomplish the processes described herein are within the scope of the disclosure.

In configurations using a single controllable LED emission area, operation can be done with what is referred to as “static-TCA”. Simply looking at the test area temperature increase can yield TCA information. However, using a spatial filter with both additive and subtractive components, even cleaner signals can be easily seen. When temporal information (e.g., toggling the LED in time, then doing frequency-domain analysis, curve fitting, etc.) is used, the process may be referred to as “static-temporal-TCA”.

In configurations using multiple LEDs or multiple regions on a single LED module that can be toggled, then the additional spatial control can be used to obtain more complex data. This configuration is referred to as “spatial-TCA”. As above, simply looking at the test area temperature increase can yield TCA information. However, by comparing the thermal signals from the test area being illuminated versus surrounding areas, even cleaner signals may be obtained. When temporal information (e.g., toggling the LED in time, then doing frequency-domain analysis, curve fitting, etc.) is used, the process is referred to as “spatial-temporal-TCA”.

While the terms module and chip may be used somewhat interchangeably herein, it should be understood one of skill in the art understands that both modules and chips may refer to each other given the context of the embodiments and the disclosure. Module usually refers to a single physical unit that may be purchased off-the-shelf and contains an LED emitting area (LED die or the semiconductor portion), a backing board, soldering pads, and sometimes simple electronic components. Chip may be used for both module-like items as well as an individual semiconductor portion. Other terms that have been used are “LED engine”, “chip on board”, etc.

LED chips, as described herein, may include but are not limited to chips, modules, or units that contain one or more LED chips and possible additional components. There may be a single light-emitting area. There may be multiple light-emitting areas that may or may not be individually addressable (toggle-able). There may be additional components such as a thermally-conductive base on which light-emitting area(s) are placed, soldering or electrical contact pads, current-limiting resistors, LED temperature readout components, or optics such as refraction-index matching layers or lenses.

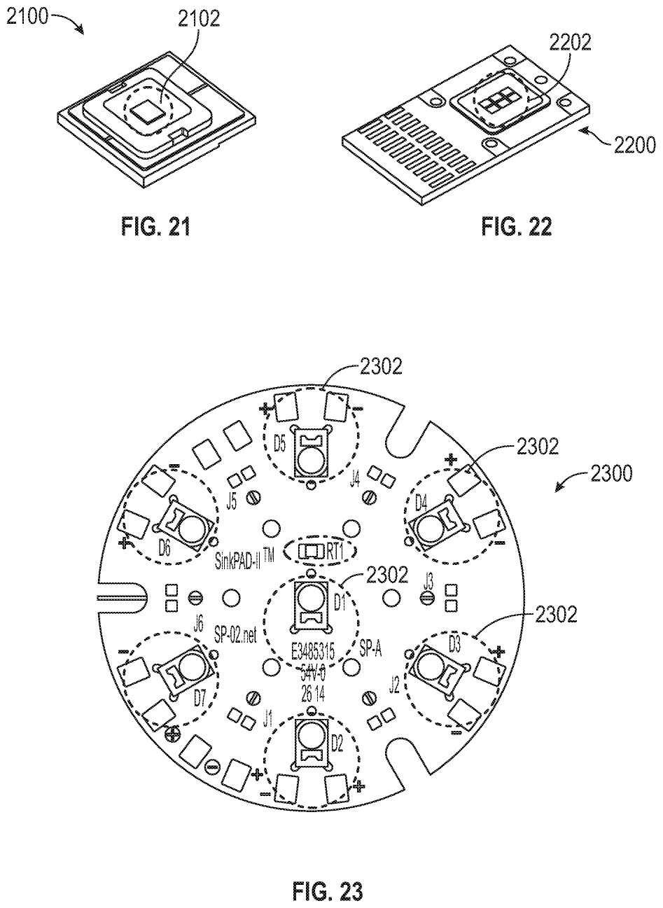

Configurations of LED chips may include, by way of example only and not by way of limitation, a single high intensity illumination area in which all LEDs present turn on and off together; multiple high intensity LEDs operating independently; a single chip with multiple independently addressable on/off areas; or the like. Further, each configuration may include a continuous or non-continuous emitting area. A continuous emitting area 2102 on chip 2100 is shown in FIG. 21. A discontinuous emitting area 2202 on chip 2200 is shown in FIG. 22. Multiple independently controllable illumination areas 2302 are shown on ship 2300 in FIG. 23. It should be understood that the configuration of areas and arrangement of independent illumination areas is limited only by design, and is contemplated within the scope of the present disclosure.

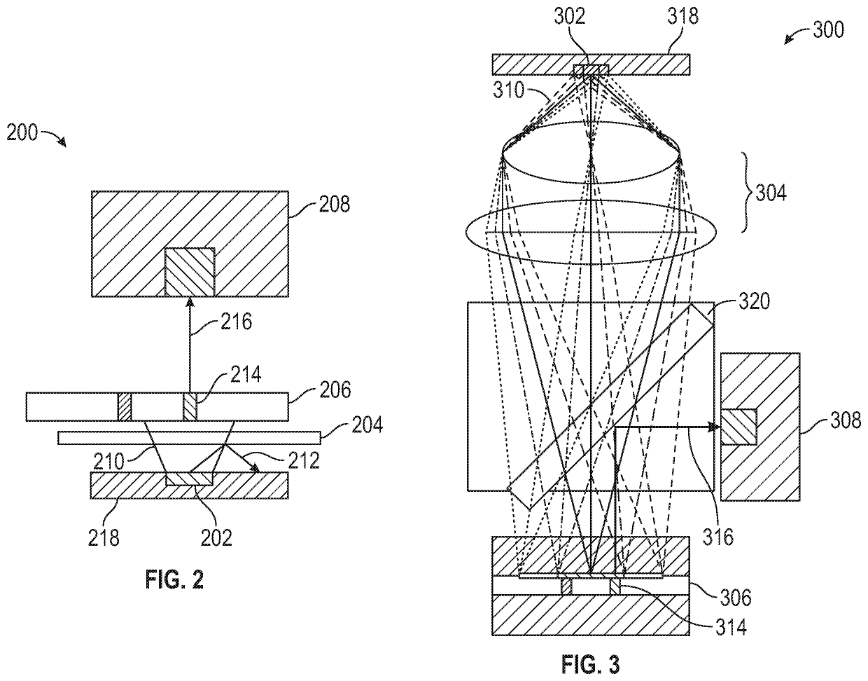

In one embodiment, a first approach with direct coupling of LED light to an LFA is illustrated in FIG. 2. Reader 200 includes an LED light source 202, a coverslip 204, a sample 206 with a test region 214, and a sensor/detector 208. LED light 210 is emitted from the LED light source 202. Infrared light is reflected as indicated at arrow 212 by coverslip 204. In one embodiment, coverslip 204 is a glass coverslip. Light passes to sample 206, and thermal sensor 208 detects the thermal energy from the test region 214 on the sample 206. Thermal imaging, as indicated by arrow 216, is performed from an opposite side of the sample than the LED illumination.

Direct heating from an LED source 202 uses the proximal placement of an LED chip 218 that houses the LED source 202 and associated circuitry. The LED light 210 is coupled directly to the sample 206. This approach is used due to rapid light divergence from LED emission regions. There is not sufficient space to place a thermal camera, or even a beam-splitting plate, to divert IR signals to a thermal camera. Thus, the thermal camera images the thermal contrast assay (TCA) signals from the other side of the sample, usually opaque due to a thick plastic LFA cartridge. It is possible that thermal signals may be imaged through the nitrocellulose membrane and the Mylar (or similar plastic) backing used in LFAs. While such an approach would simplify the optics and allows for the greatest light intensity obtained from LEDs, they would likely not be compatible with most already available LFAs. However, it is likely that a change in the outer LFA packaging would be sufficient, as opposed to a need to change the LFA strip itself.

A full LFA testing kit consists of the sample (e.g., an assay strip as seen in FIG. 1.) and an outer housing or cartridge to allow tests to be run without leaking of fluids or the risk of contaminating or damaging the LFA strip itself. This outer packaging, for the most part, plays little role in the functioning of a sample. They are merely holders for the samples which prevent fluids from leaking to the sides and to prevent damage to the strips. The samples may have a clear plastic backing (often made of Mylar) and a white, low-density membrane made of nitrocellulose (or similar plastic) filaments. The LED illumination can pass well through an average thickness and density sample from the opposite side where the test areas are fabricated. Thus, a sample cartridge/holder that provides clear optical access to the relevant area around the test area from below would suffice. That access is in one embodiment through a simple opening or through a window made of glass or plastic that is transparent to the LED light. The smaller the distance from the bottom of the LFA cartridge to the sample, the better light delivery is present.

In one embodiment, a second approach 300 having optical elements between the LED illumination and a sample is shown in FIG. 3. This approach involves simultaneous illumination, and hence heating, of both the test and background regions. This is in contrast to traditional thermal data for TCA which involves temporally distinct data points for background and test area heating. Such a “static-TCA” approach may use spatial filters, or spatio-temporal filters to extract thermal contrast signals. This approach applies to the thermal contrast assembly 200 of FIG. 2 as well. In some embodiments, background regions may be ignored.

In the reader 300, LED light 310 from LED source 302 housed on LED chip 318 is coupled via emitting area projection by an optical element 304 onto a surface of LFA 306 housing sample 314. Infrared light from the sample is reflected by angled window 320 used to separate visual and infrared light paths. Infrared light 316 from sample 314 is reflected by the angled glass 320 to be incident on sensor 308.

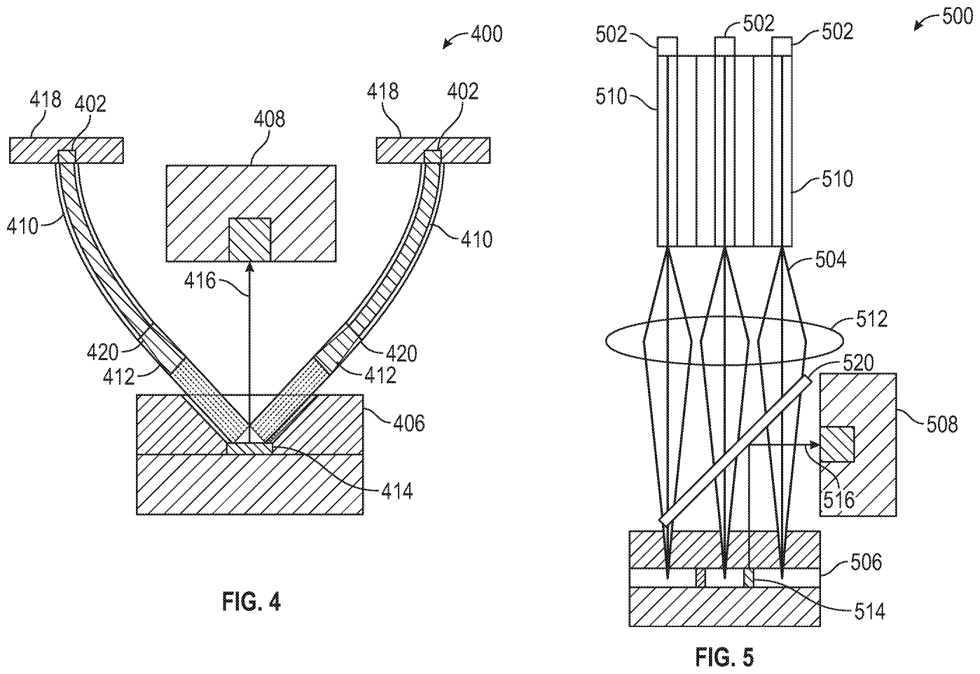

In another embodiment, a third approach 400 has LED light coupled into fiber optic cabling for delivery to an LFA is shown in FIG. 4. In the reader 400, one or more LED light sources 402 on LED chips 418 are coupled to fiber optic cables 410. The fiber optic cables 410 carry the light, and light transmitted therein is projected to the sample 414 with, in one embodiment, mini-lenses 412 which are attached at the distal ends 420 of the fiber optic cables 410, at the sample-side. The fiber optic cables (or simply, fibers) 410 present light to the sample 414. Infrared light from the sample 414 is directed toward thermal sensor 408.

One method of presentation is shown in FIG. 4 to image directly from above, with the fibers 410 angled toward the sample 414. While the angling will create a non-homogeneous illumination profile, other locations (assuming ideal fibers and lenses) will have near-identical profiles.

To allow for adequate imaging of an entire sample, or multiple specimens on a sample on an LFA 406, the reader 400 uses in one embodiment individual control over LEDs in the system. The individual control may be a simple and economical method of individually turning on and off LEDs, with one at a time being sufficient, and a method and structure for bringing the light to the sample 414.

Due to the size of the LED chips (as opposed to their emission area) and heatsinking needs, directly projecting multiple emission areas onto different locations on the sample may be difficult. However, large diameter plastic fibers with high numerical aperture (NA) and diameters, translating to high light capturing at a significantly lower price than glass fibers, may be used. Such an approach is effective for transmitting light from LEDs in spatially confined situations. Such large diameter plastic fibers have ˜0.5NA, and a capture efficiency of around 25%. Assuming further losses between the fiber and the sample, a final intensity of over 5% of LED surface at the sample is still possible. This final intensity allows for about 35 mW/mm², or the level of a 20 mW laser with 1.2 mm beam diameter.

In another embodiment, a fourth approach 500, similar to the reader 400, has a fiber bundle 510 (for example, a compact or sparse fiber bundle of one of a variety of configurations) coupling light 504 from LED sources 502 therethrough to a lens 512, and using an angled glass window 520 such as in reader 300, to allow imaging of infrared light 516 from sample 514 to sensor 508. The output of each fiber 510 is more homogenous than from non-bundled fibers 410 of reader 400, as the light inside the fiber bundle 510 undergoes several randomized reflections (the primary principle behind light pipes).

In another aspect, a lab-calibration using a photodiode with a pinhole on a motorized stage and a calibration strip (usable outside of a lab setting) may be added to the readers 200, 300, 400, or 500 and may be used to allow for final corrections. In one aspect, this would be a once per instrument (as production check) and likely a yearly or so calibration step.

Having control over what part of the LFA is illuminated, such as by toggling of individual LEDs.

This approach may be referred to as spatial-TCA.

Methods of illumination patterning according to the various embodiments discussed herein may include processes for presenting, focusing, gathering, and measuring infrared light from an illuminated sample, including methods for illuminating samples as described elsewhere herein.

For example, in readers 200 and 300, a single LED emitting surface is used to illuminate the LFA. A single large area, typically rectangular in shape, is illuminated, and this shape and spatial pattern cannot be changed. This is referred to herein as “Static-LED-TCA” or “static-TCA”. The LED intensity in these approaches can be modulated in time in analog or binary (on/off) fashion. This is referred to herein as “Static-Temporal-LED-TCA”.

In readers 400 and 500, each LED may be individually addressed. Thus, a single spot on the LFA (light from the specific fiber coupled to the specific LED turned on) is illuminated. Thus, individual spots on the LFA can be illuminated separately. This is referred to herein as “Spatial-LED-TCA”. As before, each LED intensity can be modulated in time in analog or binary (on/off) fashion and referred to herein as “Spatial-Temporal-LED-TCA”.

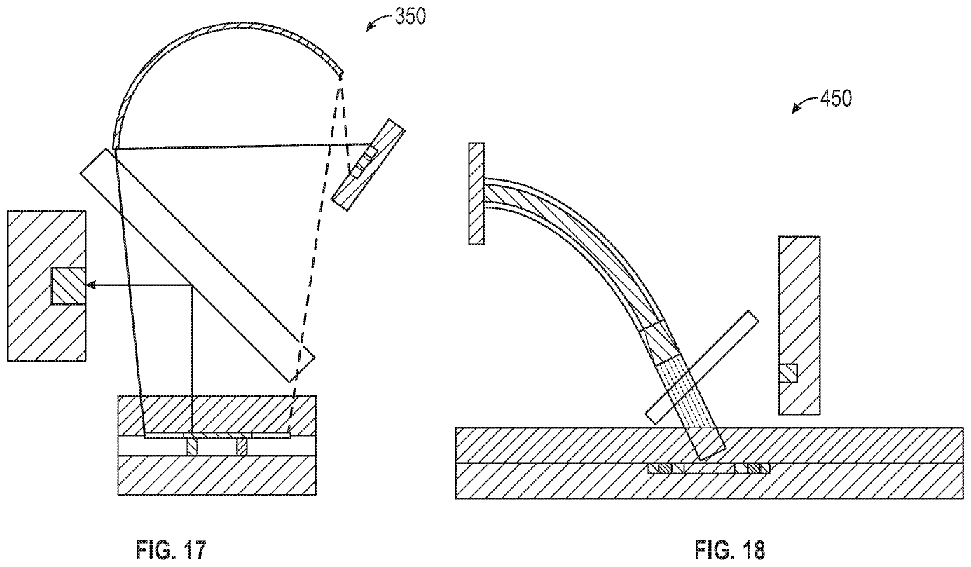

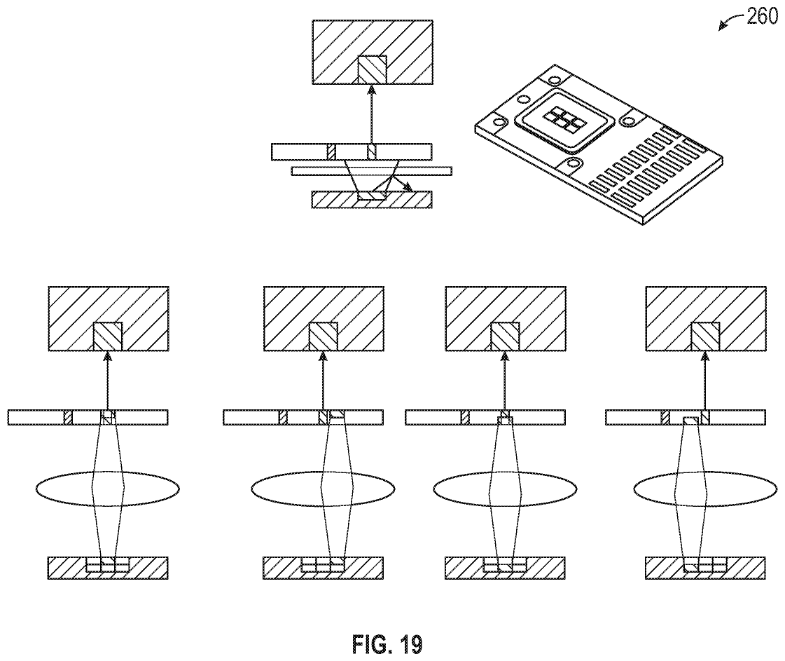

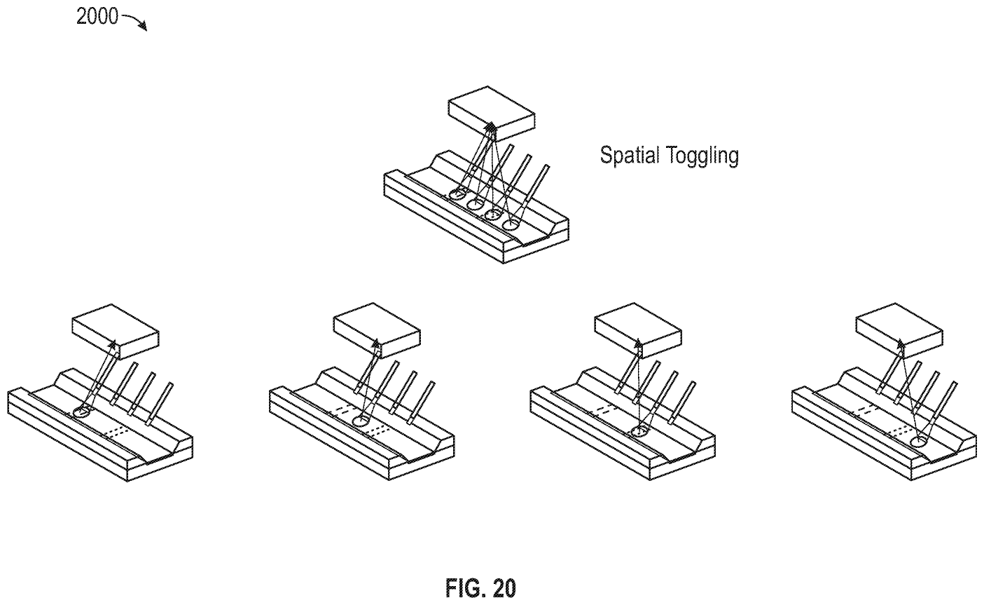

It should be understood that the embodiments discussed herein provide some ways of using optics and optical components, but that other ways to illuminate and capture emitted light/heat may be used without departing from the scope of the disclosure. For example, where lenses are used, fiber optic bundles could be substituted, and vice versa. Where a single LED source is used, multiple sources may be used, and vice versa. A multiple LED module with individually addressable LEDs may be used in place of multiple single LED modules, and the like. FIGS. 16-18 show some possible alternative embodiments. FIG. 16 shows a fiber/light pipe guide option 250 to the embodiment 200. FIG. 17 shows a focusing mirror option 350 to the embodiment 300. FIG. 18 shows a single fiber beamsplitter option 450 to the double fiber embodiment 400. FIG. 19 shows a special toggling configuration option 260 with a single module having multiple controllable areas used with embodiment 200. Such an option is also usable with embodiment 300. FIG. 20 shows a representative spatial toggling option 2000.

Accordingly, different arrangements of components and elements may be used without departing from the scope of the disclosure. By way of example only and not by way of limitation, such different arrangements include:

The LED (or the optics bringing the light to the LFA) and the sensor (or the optics bringing the infrared to the sensor) may be on the same side, as viewed by the surface of the LFA.

The LED (or the optics bringing the light to the LFA) and the sensor (or the optics bringing the infrared to the sensor) may be on opposite sides, as viewed by the surface of the LFA.

The LED light and/or sensing may be brought in or sensed on both sides of the LFA. A sphere of LEDs with one gap for sensors right above the LFA may be used, for example. A hemisphere of LEDs and a hemisphere of sensors may be used, both above and below the LFA's surface.

In each such case, the LED light may be coupled directly, or through a combination of optical elements including but not limited to: optically transparent windows, light pipes, lenses, fiber optics or similar flexible light guides, mirrors, prisms, diffusers or light shaping optical elements, polarizers, wavelength-based “dichroic” beamsplitters, beamsplitters, filters, gratings, and wavelength converters. An optical design will be suitable for the uses described herein when the LED light is transmitted from the LED to the LFA sample, possibly with spatial information preserved in some form (LED pixelation, “pixelation” by a set of fibers or fiber bundle, etc. or by spatial toggling of LED emission areas.)

In each such case, the infrared signals emitted from the LFA sample may be coupled to the sensor directly or through a combination of optical elements including but not limited to: windows, light pipes, lenses, fiber optics or similar flexible light guides if transmitting the infrared signal, mirrors, prisms, diffusers or light shaping optical elements, polarizers, wavelength-based “dichroic” beamsplitters, beamsplitters, filters, gratings, and wavelength converters. An optical design will be suitable for the uses described herein when the infrared signal is transmitted from the LFA sample to the sensor, possibly with spatial information preserved in some form (sensor pixelation, “pixelation” by a set of fibers or a fiber bundle, etc. or by spatial toggling of LED emission areas.)

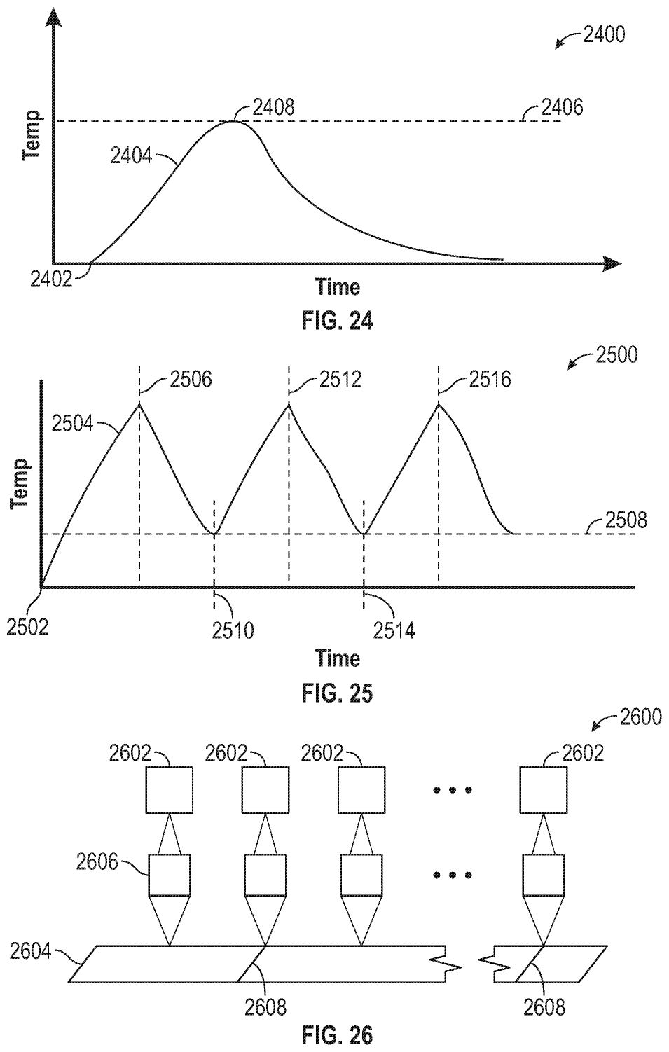

Temporal control of LED illumination is used in one or more embodiments. Temporal control in one embodiment controls intensity of an LED or LEDs in time. Implementations may include but are not limited to: 1) monitoring of temperatures of the system or sample, resulting in a shutoff command to turn off the LED(s) when a threshold temperature is reached or exceeded. This is done in one embodiment to prevent burning or damage to the system or components thereof, and is shown in graphical form in FIG. 24. 2) Modulation of LED(s) in time including repeated pulses or periodic waveforms. Appropriate timepoints or frames from a temperature (or other heating proxy) readout may be averaged. This is shown in graphical form in FIG. 25. In addition, such signals can be analyzed in the frequency domain using Fourier transforms and other known methods to extract a thermal signal.

Referring now to FIG. 24, monitoring LED temperature is performed to avoid overheating of LEDs as shown in graph 2400. Graph 2400 has time on its horizontal axis and temperature on its vertical axis. An LED turns on at 2402. The temperature of the LED increases as shown in the plot 2404. When a threshold temperature 2406 is reached, at point 2408, the LED is either shut down or reduced in intensity to avoid damage to either the LED or the sample. The threshold temperature 2406 is in one embodiment predetermined.

Referring now to FIG. 25, LED modulation is shown in graph 2500. In FIG. 25, repeated pulses of LEDs allow for multiple readings that may be averaged for a more reliable result. Graph 2500 shows LED turn on at time 2502. A temperature plot is shown at 2504. At time 2506, the LED is turned off, and a cooling period begins. A temperature threshold 2508 is reached on cooling, and at time 2510, when that temperature 2508 is reached, a second reading cycle begins. The LED turns on at 2510 and heats to time 2512, at which point it is turned off again until the temperature reaches the threshold 2508 at time 2514. The heating periods, between time 2502 and 2506, and between 2510 and 2512, may be averaged to set a third heating time between time 2514 and 2516 for increased reliability of readings. While two primary and one time/temperature averaged readings are shown in FIG. 25, it should be understood that a different number of readings may be taken without departing from the scope of the disclosure.

Thermal contrast as used in the embodiments of the present disclosure, while discussed largely as a temperature, may be any indicator of temperature variation, including but not limited to temperature change or temperature differential over time, without departing from the scope of disclosure.

While temperature has been used and described herein, the terms temperature and/or thermal sensor are used to broadly describe any method to detect temperature changes that underlie the analysis of thermal contrast signals. Sensors do not necessarily provide an absolute or even relative temperature change in standard units such as Fahrenheit, Celsius, or Kelvin. Measurements may not necessarily correspond to the temperature at a time, but instead to a change in temperature over time or other measurements that indicate an underlying temperature change. Temperature change detection does not need to rely solely on the use of infrared photons emitted due to temperature changes. Instead, temperature change detection may use, by way of example only and not by way of limitation, changes in color (thermochromic dyes), luminescence, fluorescence, resistance, generated current, generated voltage, or the like, that correlate with heating of a sample. Measurement methods may be other than non-contact or optics-based.

For example, diode or thermopile detectors with single pixels or multiple pixels, arranged in configurations including but not limited to linear and rectangular arrays, may be used. Additional optics such as lenses and apertures may be used to further enhance signals or limit the field of measurement. One embodiment 2600 of single pixel sensors 2602 covering a sample 2604 is shown in FIG. 26. Each detector element 2602 detects IR light signals from illumination of the sample 2604. In one embodiment, the sensors 2602 receive optically enhanced light through, for example, lenses and optics 2606 which are discussed elsewhere herein. While shown as single pixel sensors 2602, sensors may be arrays of sensors or the like in other embodiments.

Signals from pyroelectric detectors are more related to the change in temperature in time as opposed to an actual temperature at a specific time. These signals may also be used.

Color cameras, cameras with color filters, photodiodes, and similar detectors are used in various embodiments in place of traditional thermal sensors relying on IR. These sensors and methods of sensing detect changes in the amount of photons in specific ranges of the light spectrum, in some embodiments but not limited to the visual range, resulting from temperature changes. A shift in color with thermochromic dyes or an increase or decrease in luminescence or fluorescence may also be employed, for example.

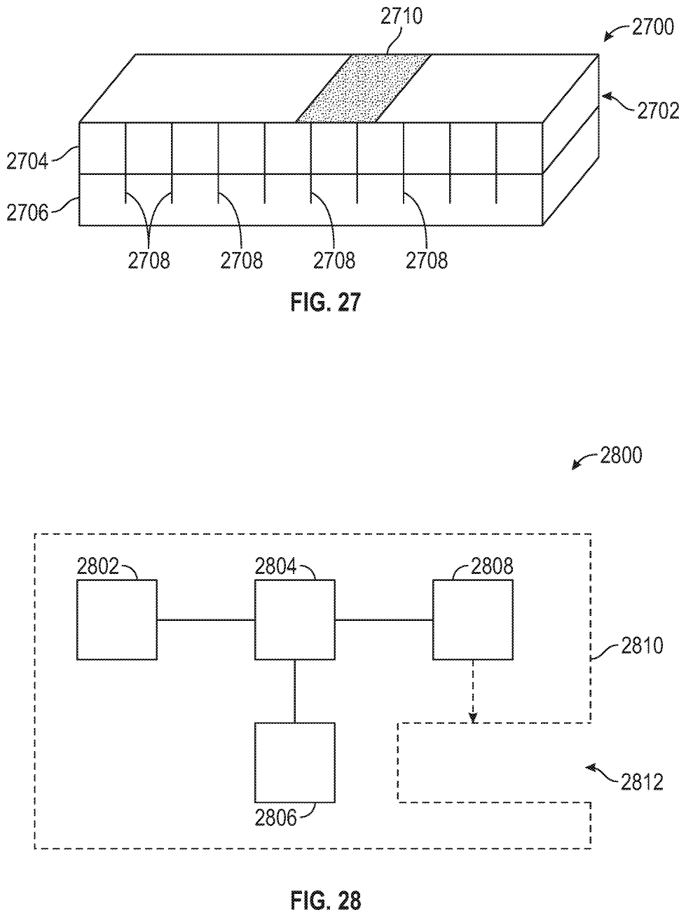

Contact methods are used in one embodiment to detect electrical property changes of a sample after receiving a specimen. For example, as shown in FIG. 27, an embodiment 2700 with an LFA 2702 having a sample membrane 2704 over a moderately electrically-conducting backing 2706 (e.g., ITO or AZO film, silicon, germanium, thermistors, or the like) or in contact with such a surface creates changes in electrical conductivity that are dependent on temperature. A set of electrical contact pins 2708 may be used to map pairwise or other conductivity measurements that can be used as a signal corresponding to a temperature change of the sample. In the vicinity of a test area 2710, the most heating occurs. This heat reaches the doped backing, and changes are detectable. In addition, use of lenses and apertures, as in intermediate optics, can limit measurement locations on the sample.

The sample membrane 2704 and/or backing in one embodiment is doped with a thermochromic, luminescent, or fluorescent dye that changes color, emission of light, or fluorescence amount with heating. The same approach may be applied to a sample that changes properties measurable by contact with the membrane. For example, this includes in one embodiment the addition of one or more contact thermal sensors (e.g., thermocouple tips) that touch the sample to replace a thermal camera or other sensors. In an embodiment, an array of contact points is used to measure resistance across test points to map the spatial profile of heating.

FIG. 28 illustrates a representative system 2800 according to embodiments of the present disclosure. Components of such a system 2800 may include but are not limited to a power source 2802, circuitry 2804 for timing, data acquisition and control, a processor 2806 (e.g., a microprocessor or the like), optics 2808 which may include LED illuminations sources and associated lenses, mirrors, and the like as discussed elsewhere herein, and a housing 2810. The power source in one embodiment is an internal power source such as a battery or the like, allowing the use of the system 2800 as a portable system. In other embodiments, power source 2802 may include connections for an external power supply such as mains electricity or the like. The power source 2802 may include voltage to LED voltage converters, current sources, batteries, or the like. A computer or processor 2806 may include some or all of the circuitry 2804. Optics 2808 may be referred to as an optical readhead, and may include LED illumination source(s), optical and/or thermal sensors such as but not limited to a thermal camera, and other lenses, mirrors, and the like. Housing 2810 includes an opening 2812 such as a slot or other opening for receipt of a sample, such as an LFA or the like.

Optics 2808 may further include remote light provided from a distance, such as over fiber optic cables or the like. In this configuration, LEDs that provide illumination may be remotely located and optically coupled into the housing 2810 by fiber optics, light guides, or the like. Optics may include optical elements near the LEDs and/or the light guides/fiber optics. Such configurations are used when form factors would benefit from such an approach (e.g., high-density sample racks) or if the illumination source is in a chamber with more active cooling methods (better airflow, active fans, coolant pipes, Peltier coolers, etc.) that allow for stronger driving of LEDs or more repeated sample reads.

The various components are in various embodiments organized and implemented with a shape and form factor in a modular way to meet specific needs of a user. Such implementations may include a fully handheld system; a system with portions that may be carried in a backpack or fanny pack with cables for signal or power to a smaller handheld unit; all-in-one desktop implementations; a rack style where many readheads may be placed close to each other with perhaps a single computer controlling many units, or the like.

In addition, designs are not limited to one computer/processor for each readhead or full system unit. As used herein, processor/computer may refer to standard central processing units (CPUs), microprocessors, and similar chips capable of controlling such systems. The system 2800 may further include a display or displays, peripherals such as a keyboard, mouse, touchscreen, trackball, pointer, universal serial bus (USB) ports, barcode scanners, or the like.

Additional illumination may be used to illuminate a sample or other portion of the system 2800. Such illumination, especially if in multiple colors or combined with a color camera, can be used to detect information indicative of contamination such as dust or blood in samples. This information may be used to exclude regions from TCA analysis. In addition, components to heat or cool parts of the system or sample may be used. A traditional fan such as those seen in computers and laptops could be used. Micro-machined and micro-electromechanical systems (MEMS) devices that can act to circulate air or otherwise affect cooling or heating may also be used. In addition, heating elements such as IR lamps or resistance coils and cooling elements including heatsinks, Peltier cooling devices, and ionic wind generating cooling devices without moving parts may be used. Heating beyond that from the LED can be used to dry a sample quicker, which can lead to signal increases as well as to preserve samples, as dried samples are often highly repeatable across days and months. Cooling systems may be used to drive LEDs stronger and longer than without cooling. Sample cooling, especially on dry samples, may be used to speed the time between trials to improve signal-to-noise of measurements in a given time period.

Exemplary designs using LEDs and optical components available from multiple sources that illustrate the variety with which LEDs can be used for TCA follow.

### For Optical Substrates as a “Beamsplitter”

The said “beamsplitter” separates the LED light from the infrared light used by the sensor. Said beamsplitter may be made of glass, plastic, or similar optical substrate (calcium fluoride, magnesium fluorite, sapphire) transparent to the LED light but reflecting of infrared light. In this scenario, the LED module is placed in the optical pathway that is more directly transmitting to the LFA sample, while the sensor is placed in the reflected optical pathway.

In an alternate implementation, the beamsplitter may be made of germanium or similar optical substrate transparent (AMTIR-1, gallium arsenide, cadmium telluride) to the infrared light but reflecting of LED light. In this scenario, the sensor is placed in the optical pathway that is more directly transmitting from the LFA sample, while the LED is placed in the reflected optical pathway.

### For Optical Substrates to Enhance Signals

A glass, plastic, or similar optical substrate (calcium fluoride, magnesium fluorite, sapphire) transparent to the LED light but reflecting of infrared light and/or thermally insulating may be positioned in between the sample and the LED but not between the sample and the sensor. This window may be built into the LFA cartridge, the reader, or both. Such optical substrates allow the LED light for TCA through to the LFA sample area, but reflect back any infrared emanating from the LED which will heat up when used. This infrared from the LED is a contaminating source of thermal signals that can reduce sensitivity to the infrared light from the LFA sample that is used for TCA. In addition, a portion infrared light from the LFA sample that otherwise may be lost may be reflected back towards the sensor, increasing the signal strength.

A germanium or similar optical substrate (AMTIR-1, gallium arsenide, cadmium telluride) transparent to the infrared light but reflecting of LED light and/or thermally insulating may be positioned in between the sample and the sensor but not between the sample and the LED module. This window may be built into the LFA cartridge, the reader, or both. Such windows can be used to enhance thermal insulation from the surrounding environment, leading to larger temperature rises. In addition, by reflecting the LED light back to the sample, it can aid in the increase of temperature rises.

A specialty plastic or similar optical substrate (barium fluoride) transmitting both LED light and infrared light may be used as a protective covering, window, or to add thermal insulation to the LFA sample that lies in the optical path from the sample to the LED and/or the sensor. Substrates used in such a manner may enhance the thermal signal build-up by the LFA sample when illuminated if thermally insulating.

A mirror or similar optical substrate (highly polished metal sheets or metallized coatings) reflecting both LED light and infrared light may be used as a protective covering, window, or to add thermal insulation to the LFA sample. Substrates used in such a manner can 1) reflect LED light that passes through the LFA back onto the sample, enhancing the intensity of the LED light that will be used for TCA, 2) reflect infrared light that is emanated away from direction towards the sensor back to the sensor, enhancing the infrared signal captured, or 3) enhance the thermal signal build-up by the LFA sample when illuminated if thermally insulating.

### For Optical Substrates as a “Window”

The thermal signal (in the form of infrared) from the LFA to the sensor is used in TCA technology. Thermal signals from the LED can be an undesirable masking signal of the LFA's thermal signals.

For the embodiment 200 in particular, a specific use of the above is to have an infrared-reflecting but optically-transparent material in between the LED and the LFA, but not from the LFA to the sensor. This is done to reduce the undesirable infrared light from the LED coming through the LFA, masking or reducing the proportion of infrared light captured that is resulting from LFA heating. For most other designs, the use of lenses, fiber optics, etc. will take care of this issue. Any number of optical designs and elements can be used for this purpose.

### Lens (or Lens or Optical System) and Fiber Optics

For illustrative purposes, single or two-lens systems are described. However, these optical systems may consist of multiple lenses and additional optical elements including fibers, light pipes, and mirrors, as will be evident to one of skill in the art, and not as a departure from the scope of the disclosure.

In addition, for illustrations showing direct coupling of an LED (embodiment 200 coupling to the LFA or embodiments 400 or 500 coupling to fiber), there may be lenses, filters, and other optical elements used for the coupling of LED light into the fiber.

### Spatial Addressing

The illustrative examples for embodiments 200 and 300 are shown using a single LED module with a single controllable emission area. However, they may also be generalized.

Embodiments 200 and 300 may use multiple LED modules assuming that their illumination can be brought to relevant locations of the LFA sample. The size of high-power modules typically make this difficult, but not impossible. For example, fibers could be used to bring in light from individual LED modules to directly under the LFA sample in embodiment 200. In these cases, the window for blocking infrared light from the LED will usually not be needed. An LED module with a single emission area but individually addressable portions could also be used.

In these cases, “Spatial-TCA” applies to embodiments 200 and 300.

Designs 400 and 500 illustrate designs with multiple fibers. These fibers may be coupled to individually addressable emission areas or to a single, large emission area.

In the case that there is only one illumination pattern possible from the LEDs (e.g., there is only a single emission area with independent control), then “Static-TCA” applies to these designs.

Most generally one or more LED modules may be used, and each may have one or more independently controllable LED emission areas.

For fiber coupling, there may be one or more fibers on the same LED module or even same LED emission area. If the LED emission area has a rectangular shape of 2 mm×1 mm, for example, two 1 mm diameter fibers may be used to collect light from the emission area.

### Algorithms Relating to Image Acquisition and Analysis of Various Forms of TCA.

### Use of One or More Pixels as the Region of Interest (ROI)

“Static-LED-TCA” may use Gabor filters and/or other similar filters that contain subtractive components that surround additive locations. In particular, the transition from subtractive, to additive, to subtractive is performed in a direction orthogonal to a test area and along a primary axis of the LFA (direction of sample flow). The transition from subtractive-to-additive happens at or near the test area and background transitions. Within each additive or subtractive region, the weights for pixels of different locations may be adjusted accordingly. These weights may shift in time (time of illumination) to correct for thermal diffusion. Similar additive-subtractive-additive algorithms can also be used.

“Spatial-LED-TCA” may use individual spots that can be illuminated individually. Those corresponding to the test area are pooled and those corresponding to background regions are subtracted from this. The pooling could consist of but is not limited to weighted averages.

“Temporal-TCA” illumination patterns can further use Fourier transforms, deconvolution, or fitting of known heating and cooling curves to further improve signal-to-noise ratios.

### Example—Direct LED Placement Under Sample

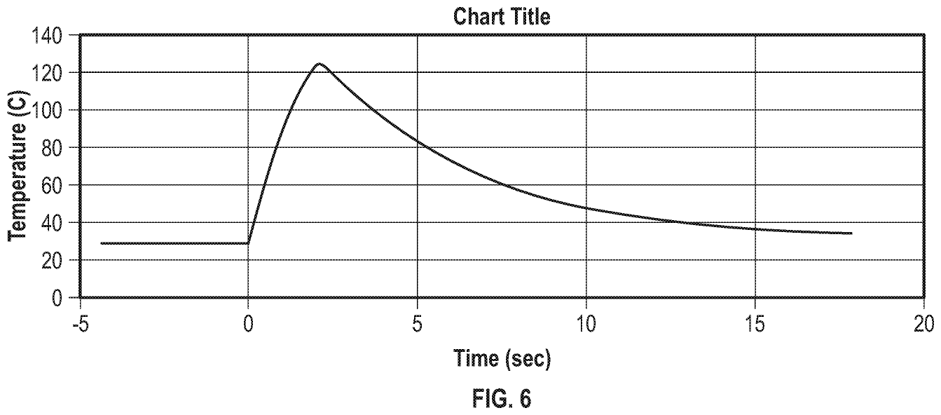

An exemplary model of a reader such as reader 200 follows. In this approach, an LED is placed in high proximity to a sample, with only a narrow air gap and glass coverslip separating the LED and the sample. The glass and air gap are used to reflect back infrared light from the LED. The sample is imaged from the opposite side as illumination. The process of the example is described below.
1. An LED chip was placed under a sample, with a glass coverslip and a <1 mm airgap separating the LED and coverslip.
a. No additional lensing to “contain” or “keep” the light, so there is natural spreading from LED.
2. Thermal images were acquired from above.
3. Background reached 125 C within 2 seconds of illumination at maximum power, as is shown in FIG. 6, with time on the horizontal axis and temperature on the vertical axis.

### Advantages of Direct LED Placement

One advantage of this approach is the extreme compactness and lack of need for optical components, with an effective 100% illumination capture. Thus, for size, cost, and power efficiency, this is close to a theoretical maximum. This approach is not compatible with standard LFAs due to the LFA-holding cartridge. However, a modification of the LFA cartridge, to allow for windows of light transmission through the LFA, and for minor changes to geometry and structure, should allow feasible use. For example,
1. NC membranes and Mylar are already relatively compatible. Further changing their properties (lower density, thinner, Mylar swapped with another plastic) is relatively straightforward.

### Challenges

1. Whether this direct placement has good homogenous illumination must be tested.
2. Use of compact lenses, light pipes, etc. could still be considered.
3. Designs of LFA cartridge (in conjunction with a reader) to improve this approach will be needed.
4. Testing of LFA samples (or commonly used materials) could be considered.
5. Test limits of TCA sensitivity with this configuration.

### Sample Configurations

A number of changes for sample design, for example its shape and configuration, and various components thereof, are used in various embodiments to enhance the cost and form factor of the LED-TCA implementation or to improve TCA signals. Sample changes may allow for more economical and simpler optical systems, or generate higher TCA signals with the same LED intensities. Accordingly, changes may be made to physical dimensions and shapes of a sample itself, especially in the portions thereof where GNPs or other thermal-contrast generating molecules will flow through or on and adhere as appropriate.

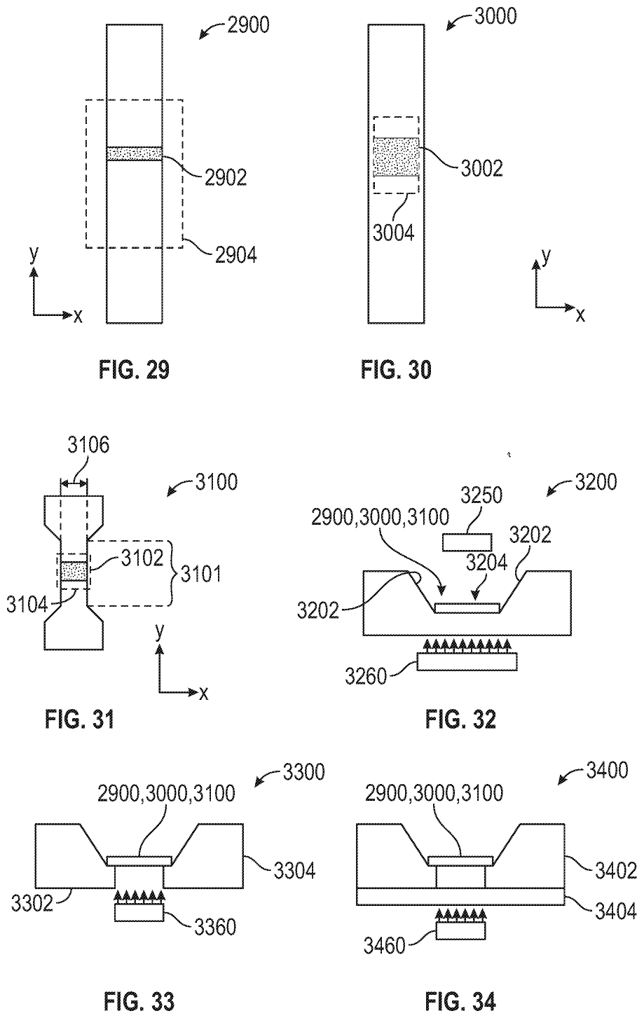

A typical LFA, for example, only has narrow 0.5 to 1 millimeter (mm) thick test areas when viewing along a length of the LFA in the y-direction indicated on the figure. A traditional LFA cartridge 2900 is shown in FIG. 29. The test area 2902 is illuminated by a large rectangular illumination region 2904, which has a substantially larger area than the test area.

LFA designs that may be used with various embodiments of the present disclosure are shown in representative form in FIGS. 30-31. Cartridge designs as shown in representative form in FIGS. 32-34 may be modified from the traditional opaque, closed-back, and sloped sides of standard LFAs.

A modified LFA 3000 is shown in FIG. 30. LFA cartridge 3000 has test area 3002 which is substantially thicker in the y-direction of the figure than test area 2902. The illumination region 3004 is narrowed in the x-direction so that more of the illumination region is incident on the test area 3002 than in the traditional LFA 2900. This results in stronger signals for a given amount of target analyte on the LFA 3000.

In some embodiments such as that shown in FIG. 30, the width across the LFA may be larger than the area of illumination, and hence some of the thermal-contrast generating molecules may be lost outside of the illumination region. As shown in FIG. 31, LFA 3100 has a narrow region 3101 where the test area 3102 resides. The width 3106 of the LFA 3100 at that region 3101 is the same as a width of the illumination area 3104. This narrowing of the flow of a specimen on the LFA section narrow region 3101, that is, at a bottleneck, helps in concentrating antigens and improving GNP binding as well.

Such configurations as shown in FIGS. 30 and 31 can be used, for example, to have a rectangular test region that is 3 mm×3 mm, and an illumination region of 3 mm×5 mm around it, or an illumination region of 5 mm×5 mm around it to observe heating of the test region and the background.

In the various LFA configurations of FIGS. 30-31, instead of using only optics to match the illumination area as best as possible to the sample, a sample and its test regions are designed to more closely match the illumination and potential optics such that it reduces the cost and complexity of the optics used to generate usable LED-TCA signals.

Still further, components, layers, or surfaces of the sample may be modified to enhance the illumination intensity or TCA signal collection.

For example, a traditional LFA with the backing replaced with glass instead of plastic reflects IR photons that would be otherwise lost back towards a sensor. Replacing that backing with a mirror-coated surface not only redirects these IR photons but also reflects back the LED illumination towards a relevant part of the sample, effectively yielding a higher intensity illumination.

For the background (membrane, channel, etc. through which the specimen flows) and any backing materials on which the specimen flows, modification as follows to increase TCA signals may include the following:
1) Low absorption of illumination for background parts such that only the GNPs or similar generate significant heat while there is less heating from the background. Thus, there is greater contrast in the thermal signals.
2) Transparency or reflectivity of IR photons adjusted depending on the sensor method and orientation (above or below sample, etc.)
3) Low IR emissivity of selected portions to reduce background signals or heat loss.
4) Higher melting or burning temperature can be desirable as well as it allows stronger or longer illumination to get stronger thermal contrast signals and improve signal-to-noise ratios.
5) Conductivity of heat through layers or across a sample may also be modified accordingly. A low lateral thermal spread is useful in simplifying data analysis as well as reducing cooling and hence increasing thermal signals. Good thermal conductivity through the layer, for example by use of thinner layers, is useful especially in cases where TCA signals are measured from certain orientations or using non-traditional thermal sensing methods such as contact measurements of electrical properties.
6) Lowering the heat capacity of the background is also useful so that the same amount of light absorption by the GNP or similar molecules can lead to higher thermal changes. A simple example of where heat capacity is high is a damp LFA—it takes more light to heat the same amount of temperature change, and thermal signals are often weaker.

An exemplary implementation is the use of microfluidic (MF) channels on transparent glass with mirrored surfaces on the back, or alternatively polished silicon with additional IR mirroring, and a rectangular test region to bind GNPs. The silicon and/or mirrored layer helps to increase LED illumination at the GNPs and redirect IR photons generated by the temperature changes towards a detector if measuring direct IR signals from the same side as the LED. Microfluidics, with a clear structure, will have lower background heating. Thus, proportionally more of the temperature changes will result from the GNPs, which are the correlate of the amount of antigen or other molecule of interest to be detected and quantified. Glass or silicon would also have higher burning or melting temperatures than most LFAs. MFs could also be coated to have less residual and undesirable GNP being not fully washed out compared to a membrane-based LFA.

In addition, the sample running procedure in one embodiment emphasizes better clearance of GNPs and similar from the background. In one configuration, all GNP or similar are at the test area/region(s), control line/region(s), or reach the end of the sample where they are captured. There are no such molecules in the general background regions that the illumination will hit. However, traditionally, such samples are optimized for visual detection at the cost of having more GNPs not cleared well from the background area. Beyond changing the parameters of the background material to reduce this undesirable GNP residue, longer run times or use of additional fluids may reduce the visual detectability of the test area, but improve TCA if the regions around the test area have less undesired residual GNPs.

The geometry of a cartridge may be modified to allow simpler optical systems or increased LED light collection to the sample. FIGS. 32-34 illustrate various cartridges.

A lower profile cartridge 3200 is shown in FIG. 32, Cartridge 3200 has sloping sides 3202 that are generally smaller than a traditional cartridge, leaving a wider opening 3204 to an LFA for access to sensors 3250 than a traditional cartridge. Further, the cartridge 3200 has smaller vertical offsets and larger horizontal offsets than traditional cartridges to improve optical access. LED light is incident on cartridge 3200 from illumination sources 3260.

A cartridge such as cartridge 3200 may reflect or absorb a larger amount of illumination than is desired. To allow better illumination from one side and thermal imaging from the other side of a cartridge, embodiments such as an open-backed cartridge 3300 (FIG. 33) or a glass-backed cartridge 3400 (FIG. 34) to allow for transmission of the LED light to the sample. Cartridge 3300 has a cutout 3302 in its cartridge body. Cartridge 3400 has a glass or plastic bottom portion 3404 at a bottom of its cartridge body 3402. Each of cartridges 3300 and 3400 to allow for better transmission of light from their illumination sources 3360 and 3460, respectively, than traditional cartridges.

A cartridge may also be composed of multiple parts such that the primary sample portion, carrying the specimen, could be ejected into the LED-TCA system. One use of such a design is to have dust protection of the sample, with the “top half or outer casing” having a viewing window for the sample, and the “top half or outer casing” not going into the sample reading area. The opening such as opening 2812 in system 2800 may be configured to accommodate an LFA such as those described herein, a cartridge such as those described herein, or the like.

The base background material or the backing material of the various cartridges 3200, 3300, 3400, and/or LFAs, may be doped with a heat-sensitive dye, luminescent or fluorescent material.

The backing material may alternatively be doped or covered in a film that changes electrical properties when heated, or is made of such material. For example, the backing may be made of polished silicon, with a nitrocellulose LFA membrane or microfluidic channels built on top. Such a backing would reflect back illuminating light to enhance total LED illumination on the regions of interest in the sample and also provide an electrical signature of temperature changes via conductivity changes. An ITO, AZO, or similar transparent conductive film coating on plastic, possibly combined with a mirrorized surface could achieve similar results.

Other physical properties of the various components of the sample may be adjusted to increase the TCA signals generated by the LED and reaching the sensors based on the method used, such as thermal conductivity through the layers as well as thermal conductive laterally, or the absolute and relative thermal masses of the components, without departing from the scope of the disclosure.

### Example—Static-TCA Approach

A static-TCA approach uses no moving parts and a broad illumination area. An exemplary model of data from a reader such as reader 300 follows.

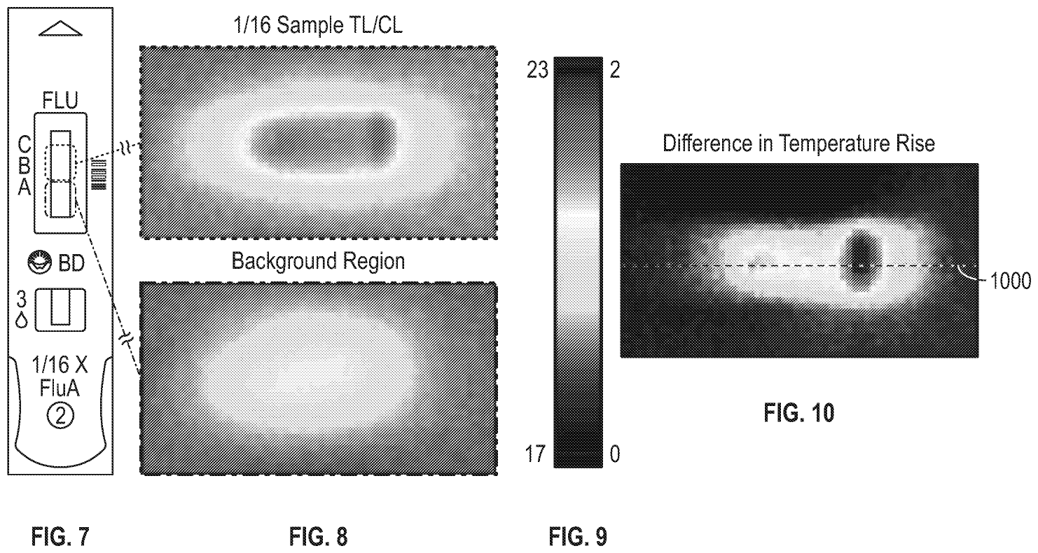

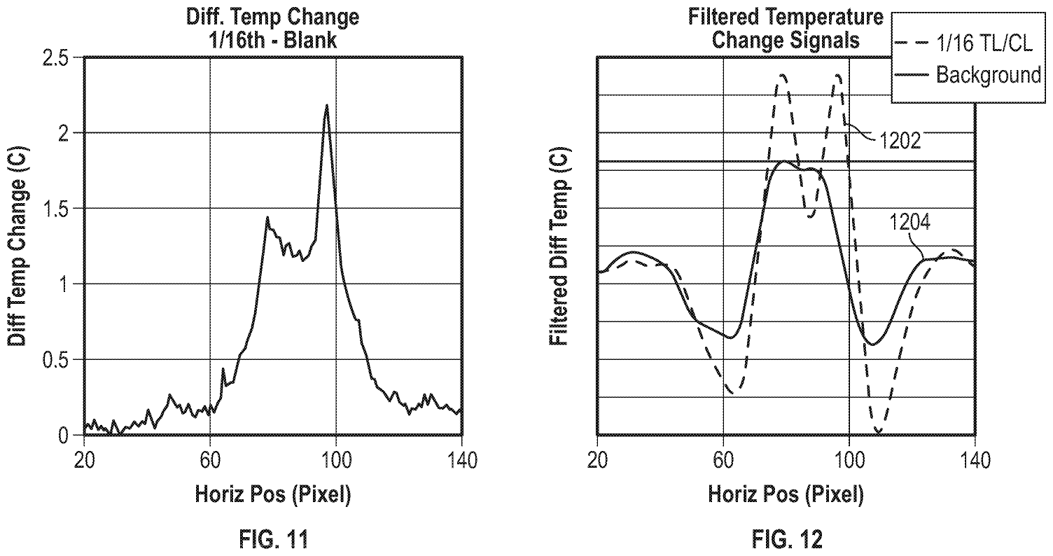

FIGS. 7-12 show example results of static-TCA and image analysis. FIG. 7 shows a 1/16 dilution “sub visual” LFA. FIG. 8 shows Raw Lepton IR thermal images from test and control line regions (top) and background (bottom). FIG. 9 shows temperature scales for raw images (left) and differential (right). FIG. 10 shows a differential image of temperature rise for the region shown to-bottom in FIG. 8. FIG. 11 is a plot of intensity of the image of FIG. 10 at the horizontal dashed line 1000 (center of heating). A small peak at pixel pos=74 may be seen. FIG. 12 is a plot of horizontal position on the horizontal axis and filtered differential temperature on the vertical axis. Strong positive signals (positive, bimodal peaks at expected locations) can be obtained by applying filters from the test and control lines 1202 compared to background region lines 1204.

### Example—Fiber-Coupled LED Array

An exemplary model of a basic, sample reader akin to a simplified reader 500 follows. In a basic experiment, two fibers were coupled to an LED using manual “holding hands” commonly used for soldering. The two fibers each had a diameter of 1.5 mm and the LED emitting area was 3.15×1.55 mm. For simplicity and compactness, in the diagram of FIG. 4, this is shown as two LED chips. No lenses were used to focus the light at the sample side. Thus, the light naturally diverged rapidly from the fiber ends. The fiber ends were brought close to the test area using similar clamping hands. Even without the lenses, steady state heating of 3 C was achieved within 3 s from a 1/16th dilution of a visual-threshold LFA with this basic manual experiment.

While this basic exemplary fiber-LED approach allows a rapid experiment, further approaches would involve 1) the testing of lens offsets and choices to increase light capture from the fiber ends; 2) assembly of multiple heatsink-LED-fiber-lens units; 3) complex CAD work to bring each system to the sample with near identical distancing and angling; 4) the extraction of TCA signals from such a system, including confirmation with a blank sample that indeed each independent fiber brought in near identical amounts of light.

Further details of a fiber-coupled LED array include:
1. In this approach, multiple LEDs, each individually addressable (one at a time), are used. The basic circuitry using LED drivers and MOSFETs is straightforward.
2. Each LED is coupled to one or more low-cost, high-NA plastic fibers. The LED-fiber coupling uses direct contact, with optional index-matching glue or oil.
3. These fibers will be brought to the sample, possibly outfitted with lenses at the sample-side.
4. Fibers from different LEDs can be turned on-and-off separately. Thus, fibers aimed at the test area can be measured separately from background regions or the control line.
5. This gives another all-solid-state approach with spatial information with TCA.
6. The electronics to control each LED serially is straightforward, and relies only on (optional) MOSFET drivers and low-resistance MOSFETs.

### Advantages Over LED Projection

1. Light collection is simplified.
a. Fibers can have diameters from 0.5 to 3 mm, in 0.5 mm increments, although smaller or larger diameter fibers and increments may be used without departing from the scope of the disclosure.
b. They have approximately 0.5 NA˜0.524 rad˜30 deg.

This approach provides only 25% light capture from the LED (assuming a fiber that encompasses the LED emitting area), compared to 40˜75% light collection with multiple high-NA lenses. However, each fiber's light is applied to a significantly smaller region, in one embodiment near 1× magnification, leading to an immediate 25% LED surface intensity benchmark.
3. Instead of simultaneous heating of a large area and subsequently more complex image analysis to extract TCA signals, the resulting data is much more akin to the “step-by-step” algorithm used in linear stage TCA.

### Disadvantages Compared to LED Projection

1. Higher size and complexity.
2. Higher cost.
3. The illumination at the end of each fiber must be corrected for by a production stage system calibration.

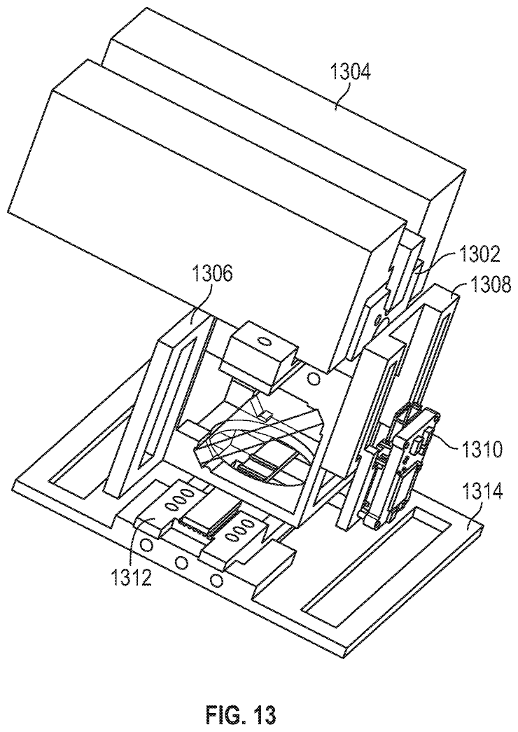

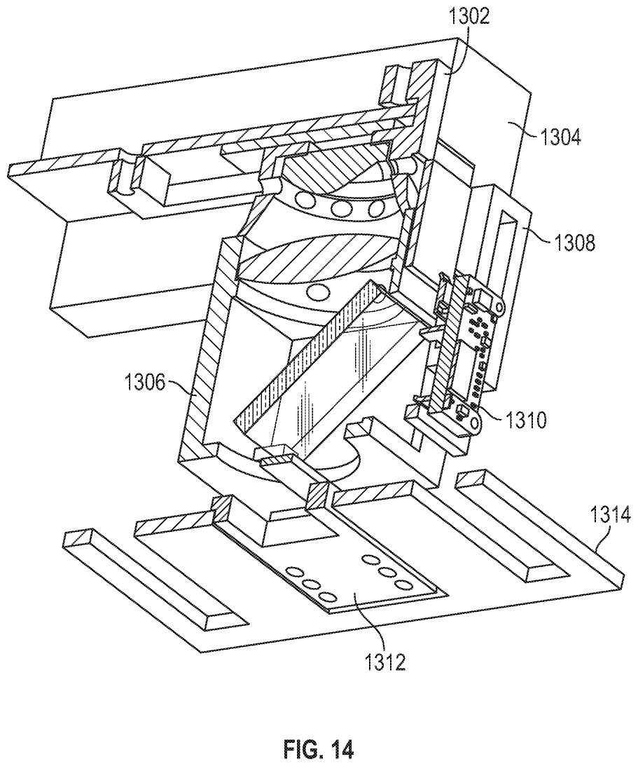

The basics of LED projection that may be used with embodiments of the present disclosure is shown in FIGS. 13-14.

In FIGS. 13 (perspective view) and 14 (partial cutaway view), basic components of a system that may be used with embodiments of the present disclosure are shown. It should be understood that different configurations, materials, components, and the like may be used without departing from the scope of the disclosure.
1302—used to hold and align the first collection lens to the LED, as well as to securely hold the LED against the heatsink (1304)
1304—heatsink
1306—optics bracket to hold both the second lens as well as a beam splitting glass plate. Slotted to allow adjustable positioning on optical breadboards or linear stages
1308—bracket to hold the Lepton IR camera
1310—Lepton breakout board
1312—LFA bare strip holder
1314—holder for the LFA holder with adjustable positioning on optical breadboards or linear stages

The system above, as well as those approaches of FIGS. 2-5, are discussed generally. It should be understood that, for each of the approaches, once the optical designs are refined (including choice of LED chip and driver), their electrical and optical characteristics will be carefully characterized, including parameters such as in-rush, peak, noise, and average electrical and optical power, in addition to trial-to-trial stability characteristics and long-term drift.

Beyond the base optical pathway for TCA, diagnostic devices such as those discussed briefly above will use additional components to maintain and/or confirm/validate system health. For example, simple circuits may determine if something is wrong with the system, but not necessarily fix the system. Circuits could however be used to maintain performance of the system up to a certain point. For example, if an LED is drawing less electrical power or a photodiode is showing that light emission has dropped, the circuit could increase voltage and current). By way of example only, and not by way of limitation, such components include:
1. Built-in components
a. Photodiode for illumination source monitoring. This could be used for PID on illumination intensity as well.
b. V and I measurements for illumination source electrical performance monitoring.
c. Camera to observe control line, proper orientation, QR-codes, etc.
d. Visible or thermal cameras for blank samples to measure illumination intensity/homogeneity, etc.
e. Temperature monitoring of the LED and “stress tests”.
2. “Calibration” methods

These are methods used “in lab” perhaps to profile the illumination intensities, etc.
a. Photodiode with pinhole on 2-axis stage to characterize light intensity field.
b. Using a camera to do similar measurements.

### Multiple Test Areas

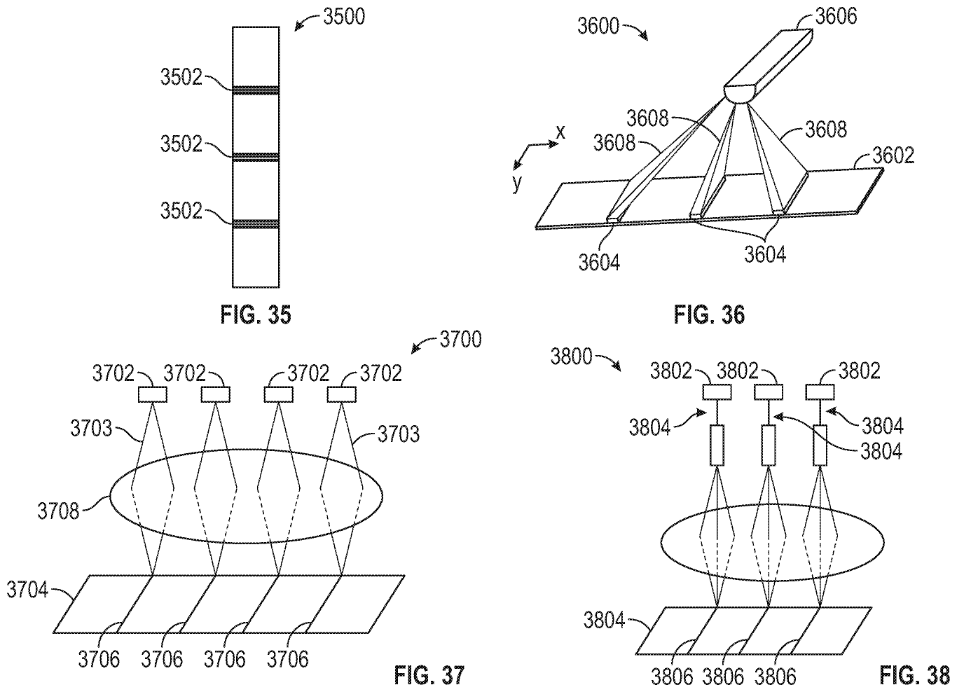

Samples with multiple test areas (e.g., test lines or regions) are also compatible with LED-TCA embodiments of the present disclosure. While the optical methods presented herein cover the approaches in general, further discussion of approaches to multiple test lines and regions follow. Multiple test areas (e.g., test lines and/or regions) are spread across a longer section of a sample. As an example, a standard sample may have a test area and a control line only 4 mm apart, and illumination would cover, for example, approximately a 3 mm×6 to 8 mm region. In contrast, a sample with multiple test areas, such as sample 3500 with test areas 3502 shown in FIG. 35, may need to be illuminated at various locations in a larger region, such as approximately 3 mm×18 mm. Magnifying the illumination source leads to a spread-out area of illumination, leading to increase waste of illumination, and also to lower intensity illumination even in the region where the test areas are present. LED-TCA embodiments address these issues in a number of ways.

FIG. 36 illustrates an embodiment 3600 employing cylindrical and/or rod lenses. Such lenses expand and focus beams in a single direction, in contrast to how a typical lens work. Thus, such lenses are used in one embodiment to stretch the illumination, for example, along a length of the sample, without expanding illumination across the sample. Thus, intensity loss is significantly less than normal magnification. A 3× magnification in one axis may lead to only a 3-fold decrease in intensity, in contrast to a 9-fold decrease in illumination intensity for a magnified illumination. Embodiment 3600 includes sample 3602 with multiple test areas (e.g., test lines/regions) 3604, and LED illumination incident on a partial cylindrical lens 3606. The light passed through the lens 3606 is spread laterally (in the x-direction on the figure) to cover the three test lines/regions laterally, but is not expanded in the y-direction.

Alternatively, as shown in FIG. 37, an embodiment 3700 includes a plurality of smaller LED chips 3702 placed together close enough together that their illumination 3703 can be collected and directed to a sample 3704 at appropriate test regions 3706 and associated background regions. This is accomplished in one embodiment by a single large lens 3708 that collects light from the LED chips 3702 and focuses it to the sample 3794. Alternatively, a lens may be used for each LED chip 3704. Additionally, further optical elements may be used between LED elements 3702 and lens 3708 (or each individual smaller lens), and/or between lens 3708 (or each individual smaller lens) and the sample 3704.

In another embodiment 3800 shown in FIG. 38, a number of LED sources 3802, not necessarily placed in specific geometries, are coupled to one or more optical fibers or light guides 3804. Each such module (LED 3802 and light pipe/fiber optic 3804) may be repeated for a region to be illuminated. The LED sources may be independent from each other, or sources from a same LED source. They may be placed on independent heatsinks or with multiple LED chips on a single heatsink. In addition, the LEDs may be placed in proximity or quite distal to the sample in this case. Additional optics may be used to enhance light collection both at the LED chip side and the sample side of the fibers and light guides.

If there are independent illumination areas or LED chips utilized, the timing of illumination can be done a number of ways. One may illuminate all regions simultaneously. One may illuminate multiple but not all regions simultaneously, and then at another time point illuminate the same or different set of regions. In such cases, it may be advantageous to illuminate regions that are non-overlapping such that the heating will not have spread from those illuminated regions such that the temperature increases will start overlapping during the measurement period. In addition, one may illuminate a single region in a serial manner, not necessarily consecutively in space or order.

Differences in illuminating and heating power between each LED chip or chip combined with optics can be accounted for by methods known to those of skill in the art, including but not limited to, adjustment of driving time (pulse duration), PWM duty cycle, start time relative to measurement periods, voltages, or currents, and as such, are within the scope of the disclosure.

### Data Analysis

LED-TCA data may be analyzed according to embodiments of the present disclosure using a number of methods. Such methods include but are not limited to the following. Algorithms may include those that use, but are not limited to analysis of peak heating; total temperature under the curve during some time period; average temperature in a time frame; or similar measurements of the amplitude of heating in illuminated regions, whether simultaneously or sequentially illuminated.

Filters may have the following characteristics and operations:

Be agnostic to the illumination and sample used; rely on information about the illumination spatial pattern; rely on information about the illumination temporal pattern or the time points of data analyzed; rely on information about negative samples and datasets of the specific model of a sample or of related or similar models of a sample; rely on information about positive samples and datasets of the specific model of the sample or of related or similar models of the sample.

Filters may include smoothing filters such as Gaussian filters; edge and line enhancing filters such as Gabor filters.

Filters may:
1) Perform or extract corrections or calculations such as a difference from a linear fit in consecutive or non-consecutive, overlapping or non-overlapping regions. Filters may include those generated by neural nets or other established or known artificial intelligence approaches trained on 1) clinical, 2) laboratory/analytical, or 3) synthesized, finite-element modeling generated datasets, or similar methods to extract thermal contrast data from LED-TCA.
2) Utilize information about locations or illumination pattern in space or analyze data in the spatial frequency domain. Filters may use information about the expected spatial location of test areas (e.g., test lines and/or regions).
3) Rely on highly uniform or symmetric illumination, including those that compare left vs right or other similar symmetric regions or asymmetric regions.
4) Correct for inhomogeneous illumination.
5) Utilize the known relative spatial positioning between certain parts of the illumination (for example, the center of the illumination) relative to test areas (e.g., test lines or regions).
6) Extract the amplitude of signals of specific widths or spatial frequencies, in particular those that may correspond to the spatial widths of the illumination; the spatial width of a test area (test line or test region) heating; or residual heating spread from previous illumination periods.
7) Analyze thermal signals not only in space (temperature profile or map), but also in changes in thermal signals across space (first derivative) or higher spatial derivatives.
8) Be time-dependent filters that may be different or changing depending on the timepoint or thermal image frames being analyzed, tailored to extract thermal contrast optimally for each of those timepoints or frames; may average multiple short trials time-locked to the onset of an illumination pulse, period, or similar timepoints; may transform the data for analysis in the temporal frequency domain; may analyze thermal signals not only in time, but also the change in thermal signals across time (first derivative) or higher temporal derivatives.
9) Analyze combined spatial and temporal derivatives or integrals.
10) Correct for other environmental factors such as drift in signal for a thermal camera or changes in ambient temperature. Such filters may use information from regions outside of the sample or other sensors as well.

Algorithms may use negative or control datasets, including those that provide an estimate or actual data on heating of samples that do not contain the target molecule(s) or analyte(s) for which the sample is designed to detect. These may include, by way of example only, measured data from samples that have not been run at all; measured data from samples that have been run with specimens that are known not to contain the target molecule(s) or analyte(s); estimated or modeled heating datasets derived from finite-element modeling or similar methods.

Algorithms may use positive datasets, including those that have been doped with known quantities of the target molecule(s) or analyte(s) or have been validated using other methods, as well as those generated by finite-element modeling or similar methods. These may be used to estimate the amount or concentration of the target molecule in the specimen.

Filters may be layered or designed by layering simpler filters via convolution or similar filter combining methods, such that each simple filter may have easier-to-understand qualitative functions such as subtraction of negative control images, smoothing pixels along the width of an LFA, or line detection along the length of an LFA.

Filters may not only yield profiles or images that indicate an amplitude, but also spatial or temporal shifts of peaks, valleys, or similar features when positive sample data is analyzed compared to negative sample data.

Filters and algorithms may detect and account for undesired contamination such as dust, based on thermal signals or as aided by cameras (either in the thermal range or visual range), ultrasonic or other profile and distance measurement methods, or user-input on inspection.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be reduced. Accordingly, the disclosure and the figures are to be regarded as illustrative rather than restrictive.

One or more embodiments of the disclosure may be referred to herein, individually and/or collectively, by the term “invention” merely for convenience and without intending to limit the scope of this application to any particular invention or inventive concept. Moreover, although specific embodiments have been illustrated and described herein, it should be appreciated that any subsequent arrangement designed to achieve the same or similar purpose may be substituted for the specific embodiments shown. This disclosure is intended to cover any and all subsequent adaptations or variations of various embodiments. Combinations of the above embodiments, and other embodiments not specifically described herein, will be apparent to those of skill in the art upon reviewing the description.

The Abstract is provided to comply with 37 C.F.R. § 1.72 (b) and is submitted with the understanding that it will not be used to interpret or limit the scope or meaning of the claims. In addition, in the foregoing Detailed Description, various features may be grouped together or described in a single embodiment for the purpose of streamlining the disclosure. This disclosure is not to be interpreted as reflecting an intention that the claimed embodiments employ more features than are expressly recited in each claim. Rather, as the following claims reflect, inventive subject matter may be directed to less than all of the features of any of the disclosed embodiments.

The above-disclosed subject matter is to be considered illustrative, and not restrictive, and the appended claims are intended to cover all such modifications, enhancements, and other embodiments, which fall within the true spirit and scope of the present disclosure. Thus, to the maximum extent allowed by law, the scope of the present disclosure is to be determined by the broadest permissible interpretation of the following claims and their equivalents, and shall not be restricted or limited by the foregoing detailed description.

1-34. (canceled)

35. A thermal contrast assay reader, comprising:
a light emitting diode (LED) source element;
a sensor; and
a sample tray comprising input/output (I/O) circuitry and an opening to receive a sample;
wherein the reader is configured to convert the sensor results to an output signal upon activation of the LED source element onto a test region of the sample, and
wherein the sensor is an infrared sensor configured to measure thermal contrast in the test region of the sample.

36. The thermal contrast assay reader of claim 35, wherein the sample tray is positioned between the LED source element and the sensor, adjacent the LED source element, the sample tray having a window configured to reflect infrared (IR) light from the LED source element while allowing the LED light to pass through.

37. The thermal contrast assay reader of claim 36, wherein the LED source element comprises an LED chip having at least one LED coupling light to the sample tray.

38. (canceled)

39. The thermal contrast assay reader of claim 36, wherein the window is a transparent coverslip comprising glass or plastic.

40. The thermal contrast assay reader of claim 36, wherein the sample tray is configured to thermally image from an opposite side of a sample from the LED source element.

41. The thermal contrast assay reader of claim 35, and further comprising an optical assembly between the LED source element and the sample tray.

42. The thermal contrast assay reader of claim 41, wherein the optical assembly is configured to couple both the view of the thermal sensor and the emitting area of the LED to a sample region, using the angled window to separate or combine visible and infrared light paths.

43. (canceled)

44. The thermal contrast assay reader of claim 42, wherein the optical assembly comprises a first lens and a second lens, the first lens and the second lens positioned between the LED chip and the angled window, the first lens and the second lens configured to present light across an entirety of the sample for simultaneous illumination of a test region and a background region of the sample tray, and the angled window to reflect infrared light from the sample to the sensor.

45. The thermal contrast assay reader of claim 41, wherein the optical assembly comprises fiber optic cable configured to couple light from the LED chip to a sample, and a lens at an end of the fiber optic cable distal to the LED chip.

46. The thermal contrast assay reader of claim 41, wherein the optical assembly comprises two LED chips, and a fiber optic cable for each LED chip, each fiber optic cable configured to couple light from its LED chip to a sample, and a lens at an end of each fiber optic cable distal to its LED chip.

47. The thermal contrast assay reader of claim 35, and further comprising a calibration component, the calibration component comprising a movable stage, a photodiode with a pinhole on the movable stage, and a calibration strip for aligning light from the LED chip source element to the photodiode for calibration.

48. (canceled)

49. The thermal contrast assay reader of claim 41, wherein the optical assembly comprises:
a plurality of LEDs on the LED chip;
a bundle of a plurality of fiber optic cables configured to carry light from the plurality of LEDs;
a lens coupled to an end of the bundle, the lens configured to distribute light from the bundle to the sample; and
an angled window positioned between the lens and the sample tray to separate visible and infrared light paths.

50. (canceled)

51. The thermal contrast assay reader of claim 49, wherein the angled window is glass and is positioned to reflect infrared light from the sample to the sensor.

52. The thermal contrast assay reader of claim 35, and further comprising a camera operating in a visible range, the camera configured to detect a presence and a proper orientation of the sample tray.

53. The thermal contrast assay reader of claim 52, wherein the camera is a CMOS camera or a CCD camera.

54. (canceled)

55. The thermal contrast assay reader of claim 52, wherein the camera is further configured to detect and read information encoded in a barcode, QR code, or similar information coding pattern of the sample tray and/or is further configured to confirm light intensity of light from the LED source element.

56. (canceled)

57. The thermal contrast assay reader of claim 35, and further comprising a light intensity measuring detector including circuitry used to validate or perform feedback power generated by the LED source element, configured to check health of the LED source element and driving circuitry associated with the LED source element, or combinations thereof.

58-59. (canceled)

60. The thermal contrast assay reader of claim 57, wherein the light intensity measuring detector is configured to check health of the LED chip and the driving circuitry by assessing an emission intensity and temporal pattern of light emitted from the LED chip.

61. A method of illumination patterning for a thermal contrast assay reader, comprising:
illuminating a specimen on a sample with LED light from an LED source; and
sensing a thermal contrast in the specimen with a sensor.

62. The method of claim 61, wherein sensing and illuminating are done from opposite sides of the sample.

63. The method of claim 61, wherein illuminating is performed with a direct illumination of the sample by the LED source or with an optical assembly between the LED source and the sample.

64. (canceled)

65. The method of claim 61, wherein illuminating is performed by coupling the emitting area projection of the LED onto the sample surface, using an angled window to separate visible and infrared light paths or wherein illuminating is performed by coupling light from the LED source to a sample through fiber optic cable with a sensor detecting thermal contrast in the illuminated regions.

66. The method of claim 65, wherein the optical assembly illuminates the sample by positioning a first lens and a second lens between the LED source and the angled window, and by presenting light across an entirety of the sample for simultaneous illumination of a test region and a background region of the sample.

67. The method of claim 61, wherein illuminating is performed by coupling light from the LED source to a sample through fiber optic cable and wherein illuminating is further performed by coupling light from the fiber optic cables through lenses at an end of the fiber optic cables distal to the LED light source.

68. (canceled)

69. The method of claim 61, wherein the LED source comprises a plurality of LED light sources, each LED light source of the plurality of LED light sources individually coupled through a fiber of a plurality of fibers, wherein each LED light source is individually controllable and wherein illumination is performed by illuminating different locations on the LFA by selectively operating an LED of the plurality of LED light sources.

70. (canceled)

71. The method of claim 61, wherein illuminating is performed by:
bundling a plurality of fiber optic cables configured to carry light from a plurality of LEDs;
presenting light from the plurality of fiber optic cables to a lens coupled to an end of the bundle; and
directing the light to the sample through an angled window positioned between the lens and the sample to separate visible and infrared light paths.

72. (canceled)
